(19) United States
(12) Patent Application Publication
(10) Pub. No.: US 2024/0218194 A1
(43) Pub. Date: Jul. 4, 2024

(54) 3D PRINTING MATERIALS

(71) Applicant: Trustees of Boston University, Boston, MA (US)

(72) Inventors: John William Boley, Cambridge, MA (US); Javier M. Morales Ferrer, Allston, MA (US); Stephanie Flores Zopf, Newtonville, MA (US); Chloe Grace Kekedjian, Cambridge, MA (US); Ramon Enrique Sanchez Cruz, Allston, MA (US)

(73) Assignee: Trustees of Boston University, Boston, MA (US)

(21) Appl. No.: 18/394,639

(22) Filed: Dec. 22, 2023

Related U.S. Application Data
(60) Provisional application No. 63/434,700, filed on Dec. 22, 2022.

(51) Int. Cl. C09D 11/023; B33Y 10/00; B33Y 40/20; B33Y 70/10; C09D 11/102; C09D 11/14; B22D 23/00; C08K 3/04; C08K 3/105; C08K 3/36

(52) U.S. Cl. CPC C09D 11/023; B33Y 10/00; B33Y 40/20; B33Y 70/10; C09D 11/102; C09D 11/14; B22D 23/003; C08K 3/04; C08K 3/041; C08K 3/105; C08K 3/36; C08K 2201/001

(57) ABSTRACT

Methods and compositions for 3D and 4D printing inks exhibit desirable electrical and rheological properties. The compositions disclosed include a 3D printing ink employing a liquid metal emulsion and a method of creating a stretchable electronic device using the same. The compositions also include 4D printing inks and methods of tuning said inks to have desirable properties.

### CROSS REFERENCE TO RELATED APPLICATIONS

This application claims priority to and the benefit of U.S. Provisional Patent Application No. 63/434,700, filed on Dec. 22, 2022, and entitled “4D Printing Materials and Uses Thereof”, the contents of which are incorporated herein by reference as though fully set forth herein.

### GOVERNMENT SUPPORT

This invention was made with government support under FA9550-20-1-0365, awarded by the U.S. Department of Defense, and under 2047683, awarded by the National Science Foundation. The government has certain rights in this invention.

### FIELD OF THE TECHNOLOGY

The subject disclosure relates to materials that can be used in 3D and 4D printing, and methods of making the same.

### BACKGROUND OF THE TECHNOLOGY

The widespread adoption of stretchable electronics depends on the development of easy to fabricate soft conductive composites that are highly compliant to mechanical deformations and maintain high electrical conductivity while being stretched. Liquid metal (LM) composites have become a popular choice since they take advantage of the electrical properties of metals while conserving the intrinsic stretchability and compliance of liquids. Alloys of Gallium and Indium, such as eutectic Gallium Indium (eGaIn), have been the most widely adopted LMs because of their high bulk conductivity (3.4×10⁶ Sm⁻¹), low melting point 15.5 C, low toxicity, negligible vapor pressure, and ability to maintain high electrical conductivity at high strains over a large number of cycles. However, directly integrating LMs into 3D stretchable devices remains a challenge.

Most techniques for integrating bulk LM into 3D devices require complex series of lithography and molding techniques. To reduce fabrication complexity, several researchers have utilized the structural stability enabled by the naturally occurring Gallium oxide (Ga₂O₃) shell to directly pattern bulk LMs into various geometries using additive manufacturing (i.e. 3D printing) techniques. However, the low ultimate surface stress (0.5 Nm⁻¹) of the printed structures limits these bulk LM patterning approaches to simple geometries (i.e. line patterns and simple 3D stacks of droplets), and makes it difficult to integrate with other components. To address these challenges, multiple researchers have investigated different approaches of modifying the rheological properties of LM to create LM inks that are more compatible with 3D printing techniques. One approach has been to disperse solid particles into a LM matrix. However, formulations with low solids concentrations are not stiff enough to extend beyond line geometries, while high solid formulations can be extruded into more complex 3D geometries, but exhibit frequent nozzle clogging.

An alternative approach to modifying LM rheology is to create micro and nano emulsions of LM droplets disperse in a carrier liquid. Stable dilute LM emulsions are compatible with droplet-based printing methods, while highly concentrated stable LM emulsions are compatible with direct ink writing (DIW) 3D printing. A challenge with LM emulsions is that the resulting structures exhibit low levels of electrical conductivity, owing to the low electrical conductivity associated with the materials used to stabilize the LM droplets in the carrier liquid. Rendering these emulsions electrically conductive typically requires a sintering step to displace the low conductivity materials and allow the individual droplets to coalesce into a single continuous liquid phase. To date, multiple approaches have been used to sinter LM emulsions. Laser-based sintering approaches have been employed to ablate the low conductivity materials.26 These approaches can be used to create 2D LM patterns within LM emulsion deposits, but are limited to thin films (10 μm). Patterned LM emulsions can be sintered through high temperatures (≥900° C.) in an oxygen-rich environment. This results in the creation of a biphasic solid-liquid eGaIn film, with the liquid eGaIn droplets experiencing large thermal expansion, coalescing the individual LM droplets. However, the high temperature necessary for this approach requires the LM patterns to be sintered separately from the other materials, resulting in a complex device fabrication process. Mechanical sintering approaches have also been employed, where the emulsion is subjected to a stress that compresses the LM droplets leading to the rupture of the oxide skin and separating materials between individual droplets, releasing the enclosed LM and coalescing the droplets into a conductive network. However, current mechanical sintering approaches require large stresses (3 MPa and 3.6 MPa) which may not be compatible with other materials that are integrated into the device.

Further, responsive materials have emerged as a focal point for researchers over the past decade, driven by their versatile applications within smart material systems. These systems are defined as smart due to their ability to change shape in response to stimuli such as change in temperature, electric, or magnetic field. Notably, they exhibit potential across a spectrum of applications such as energy-harvesting systems, smart actuators, smart textiles, and even in the development of robotic exoskeletons. Among the commonly employed responsive systems are piezoelectrics, magnetostrictive materials, pneumatic systems, dielectric elastomers, and shape memory alloys (SMAs). SMAs, in particular, stand out as preferred materials for responsive applications, primarily due to their ability to achieve localized actuation through Joule heating and their inherently high actuation stress. Nevertheless, it is crucial to underscore that one of the paramount challenges associated with SMAs is limited complexity. Recent strides in SMA technology have harnessed 3D printing techniques to confront this challenge. Despite these advancements, 3D printable SMAs still have practical limitations due to the insufficient shape-memory effect. Moreover, whether employing conventional manufacturing methods or adopting 3D printable approaches, SMAs consistently exhibit low repeatability, low reversibility, and necessitate additional pre-programming steps before or after they are manufactured. This process involves configuring the SMAs into the target shape, heating it above the martensite phase (approximately 500° C.), and subsequently cooling it down to the austenite phase (around 25° C.). In light of these challenges, there is an increasing demand for materials that are not only responsive but also possess enhanced reversibility that seamlessly align with fabrication approaches to enable complex shape change. This growing need has ignited extensive research into a spectrum of materials and innovative fabrication approaches, demonstrating considerable potential for effectively addressing these limitations.

A particularly promising avenue lies in the innovative realm of 4D printing, a rapidly emerging field where 3D printed stimuli-responsive materials produce morphing an multifunctional structures, incorporating time as the fourth dimension (note, the term 3D printing is used herein to encompass both 3D and 4D printing). This approach enables the 3D printing of pre-programmed responsive sheets, which transition into complex surfaces upon exposure to external stimuli, resulting in a substantial reduction in material consumption and printing time (70-90%). Unlike SMAs, the programming of these responsive structures is achieved through the strategic arrangement of multiple materials in three-dimensional space, employing the printing process to invoke reversible shape change (e.g., aligning magnetic, anisotropic fillers, and polymer chains). These morphing structured systems have potential for myriad applications, from deployable systems and dynamic optics to soft robotics and frequency-shifting antennae. The current materials palette for 4D printing is comprised solely of soft polymer composites (elastic modulus range 10⁻⁴-10 MPa), such as hydrogels, shape memory polymers (SMPs) liquid crystal elastomers (LCEs) and polydimethylsiloxane (PDMS). Hydrogels can be tailored for printable applications, where the printed structures demonstrate reversible swelling upon immersion in water. However, these materials are restricted to moist environments, and their elastic modulus (E) (0.02-1.3 MPa) is the lowest of any 4D printing materials. On the other hand, shape memory polymers (SMPs) are thermoplastic materials that can be programmed to change shape in response to temperature by heating the material above its glass transition temperature (T_{g}), stretching it, and cooling it below T_{g}. SMPs demonstrate a higher E in their crystalline state, extending from 10 to 3000 MPa. However, it is important to note that the mechanism of this glass transition-based response is irreversible, necessitating pre-strain for the desired transformation. Moreover, during the glass transition, there is a significant drop in E (ranging from 0.1 to 10 MPa), which places them within a similar range as hydrogels. Liquid crystal elastomers (LCEs) have been used in 4D printing as well. These materials exhibit a higher E compared to hydrogels, and their functionality is not confined to moist environments. Importantly, LCEs possess the capacity for reversible actuation, attributed to the reversible phase change of aligned mesogens. However, their E is on par with SMPs in their rubbery state (ranging from 1.2 to 12 MPa), thereby sharing similar limitations regarding low E. Moreover, PDMS composites have recently joined the array of 4D printing materials. Previous studies have demonstrated the versatility of these materials, revealing their capability to be blended with various fillers to create responsive inks suitable for 3D printable technologies. These inks can be tailored to respond to external stimuli such as magnetic fields, solvent swelling, or temperature variations. It is noteworthy that akin to previous materials, these composites also share a characteristic low modulus (ranging from 0.01 to 1.2 MPa), presenting analogous limitations to hydrogels, SMPs, and LCEs. A comparison of E for these materials is shown in the table 720 of FIG. 7d. It is evident that all these materials share a common limitation of low E while undergoing actuation. This limitation inherently restricts actuation stress, load-bearing capabilities, and the structural integrity of printed objects to support their own weight when increasing the overall dimensions of the printed parts. Therefore, an existing challenge for 4D printing is to develop materials that can maintain the large, reversible, and predictable morphing actuation mechanism for complex shape transformation, while significantly advancing the E for high performance applications.

In addition to these challenges related to low E, many existing approaches rely on passive structures that necessitate the control of global conditions of the surrounding environment (e.g., water or solvent baths, ovens, or external magnets) to provide the stimulus for actuation thus limiting their range of applications. Recently, researchers have tackled this challenge by integrating electrically conductive materials to create responsive and electrically controllable composites, which enables the introduction of local and addressable stimuli through electrical signals. However, it is important to note that the integration of additional materials solely for the purpose of inducing actuation (e.g., Joule heating) can hinder the actuation responsiveness. This is because these additional materials do not contribute to the actuation mechanism; instead, they inadvertently introduce extra weight or mechanical constraints that work against the intended actuation. Most recently, successful attempts have been made to integrate conductive materials into responsive composites (e.g. piezoelectrics) while preserving both responsiveness and load-bearing capacity, but require high-temperature sintering of piezoelectric materials, exceeding 1000° C.

### SUMMARY OF THE TECHNOLOGY

In light of the needs described above, in at least one aspect, the subject disclosure introduces a stable aqueous LM emulsion with rheology that is compatible with DIW 3D printing. In some instances, the aqueous LM emulsion is comprised of eGaIn, sodium carboxylmethyl cellulose (NaCMC), and water, and can be quickly synthesized using a shear mixer. During mixing, the eGaIn is sheared into micrometer-sized droplets and dispersed within the continuous aqueous NaCMC solution phase. The resulting emulsion has a stiffness and yield stress that are large enough so that complex, self-supported 3D structures with overhangs can be readily manufactured.

Unlike previous emulsion formulations, the disclosed emulsion requires an order of magnitude smaller stresses (<0.3 MPa) and achieves an electrical conductivity (8.61×105 S·m⁻¹) closer to that of the bulk LM. Moreover, the disclosed emulsion requires only a single axial strain to achieve high electrical conductivity, with low variation (<6% standard deviation) over 1000 cycles. Our emulsion can be readily integrated with other printed materials in a single fabrication process. Finally, we demonstrate the utility of this emulsion by fabricating a stretchable light emitting diode (LED) array.

In another aspect, to overcome the limitations of 4D printing discussed above, we disclose herein a multiscale heterogeneous polymer composites as a novel category of stiff, thermally responsive 4D printed materials. These inks exhibit an E that is four orders of magnitude greater than that of existing 4D printed materials and offer tunable electrical conductivities for simultaneous Joule heating actuation and self-sensing capabilities. Utilizing electrically controllable bilayers as building blocks, the disclosure describes a design for printing a flat geometry that morphs into a 3D self-standing lifting robot, setting new records for weight-normalized load lifted and actuation stress when compared to other 3D printed actuators. Furthermore, the disclosure describes employing the ink palette herein to create and print planar lattice structures that transform into various self-supporting complex 3D shapes. These designs are integrated herein into a 4D printed electrically controlled multigait crawling robotic lattice structure that can carry 144 times its own weight.

### BRIEF DESCRIPTION OF THE DRAWINGS

So that those having ordinary skill in the art to which the disclosed system pertains will more readily understand how to make and use the same, reference may be had to the following drawings.

FIG. 1a is a schematic of a 3D printing of a continuous filament of LM emulsion in accordance with the subject disclosure.

FIG. 1b is an optical microscope image of the emulsion of FIG. 1a.

FIG. 1c is a schematic of the LM emulsion composition of the emulsion of FIG. 1a.

FIG. 1d is a graph showing droplet size distribution of the image of FIG. 1b.

FIG. 2a is a graph of rheological properties of an emulsions and solution disclosed herein.

FIG. 2b is a graph of apparent viscosity as a function of shear rate for the materials of FIG. 2a.

FIG. 2c is a schematic of the printing process for a 3D printed structure in accordance with the 3D printing inks disclose herein.

FIG. 2d is a photograph of a 3D printed structure in accordance with the schematic of FIG. 2c.

FIG. 3a shows steps of using the process and materials disclosed herein to print a dogbone.

FIG. 3b shows a schematic of the electromechanical and mechanical characterization of a 3D printed dogbone in accordance with the subject technology.

FIG. 3c shows images of the printed dogbone of FIG. 3b being stretched from zero to four times its original length.

FIG. 3d is a graph of engineering stress as a function of engineering strain obtained from the mechanical characterization of the dogbone of FIG. 3c.

FIG. 3e is a graph of conductivity of the LM emulsion ink as a function of cycle number at different strains, in accordance with the subject technology.

FIG. 3f depicts graphs of changes in electrical properties as a function of cycle number or strain for an LM emulsion ink in accordance with the subject technology.

FIG. 4a shows a fabrication process of an LED device using an LM emulsion ink in accordance with the subject technology.

FIG. 4b shows an LED device printed in accordance with the subject technology.

FIG. 5a is a table of electromechanical sensitivity parameters at difference strains for an LM emulsion ink in accordance with the subject technology.

FIG. 5b is a table showing measures of the hysteresis for the data in graph 320 at various strain levels.

FIG. 6a is a schematic of a 4d printed filament in accordance with the subject technology.

FIG. 6b shows an SEM image of a 3D printed carbon fiber (CF) composite ink and a notational schematic of all ingredients employed therein.

FIG. 6c is a graph of the range of achievable thermal expansion (α) and (elastic modulus (E) for the composite inks disclosed herein.

FIG. 6d is a graph of the range of achievable electrical conductivity (σ) and specific volume (v) for the composite inks disclosed herein.

FIG. 7a shows graphs of measured characteristics of the composites disclosed herein as a function of CF volume fraction.

FIG. 7b is a graph of measured (σ) along the printed direction for carbon filler combinations as a function of CB volume fraction with a fixed base:cross-linker ratio of 1:0.2 by weight, in accordance with the subject disclosure.

FIG. 7c are SEM images of carbon filler combinations in accordance with the subject technology.

FIG. 7d is a table showing the elastic modulus of 4D printing materials while undergoing shape-change.

FIG. 7e is a table showing exemplary ink formulations for 4D printing materials in accordance with the subject technology.

FIG. 7f show graphs of ink rheology for ink formulations in accordance with the subject technology.

FIG. 7g show graphs of the alignment characterization of carbon fiber inks in accordance with the subject technology.

FIG. 7h shows exemplary material parameters for the materials disclosed herein, an image of those materials being subjected to strain, and graphs of the tensile strain experienced.

FIGS. 7i, 7j, and 7k show a table of effective material properties of inks designed in accordance with the subject disclosure.

FIG. 8a is a schematic of electrically controllable 4D printed bilayers formed in accordance with the subject technology.

FIG. 8b shows optical and thermal images of electrically controllable actuation, via Joule heating, of a 4D printed device in accordance with the subject technology.

FIG. 8c is a graph of measured and modeled response of temperature and strain at different power levels for the 4D printed device of FIG. 8b.

FIG. 8d is a graph of measured and modeled response of change in electrical resistance and strain at different power levels for the 4D printed device of FIG. 8b.

FIG. 8e is a graph of measured and modeled response of change in electrical resistance and strain at different power levels for the 4D printed device of FIG. 8b.

FIG. 8e is a graph of measured change in electrical resistance as a function of the number of cycles for a 4D printed device of FIG. 8b.

FIG. 9a is a schematic of a 4D printed weightlifting robot after printing, designed in accordance with the subject disclosure.

FIG. 9b shows photographs of the lifting robot of FIG. 9a being actuated and lifting 313 times its own weight.

FIG. 9c is a graph of measured responses of different lifting tests for the lifting robot of FIG. 9a.

FIG. 9d is a graph of performance metrics of different 3D printed actuators, including previously known actuators and those disclose herein.

FIG. 9e shows photographs of the lifting robot of FIG. 9a, with the measured change in electrical resistance during actuation shown below corresponding images.

FIG. 10a shows a flat lattice for structure for 4D printing, capable of shifting into a 3D likeness of Carl Friedrich Gauss.

FIG. 10b shows a schematic of a 4D printed robotic lattice in accordance with the subject technology.

FIG. 10c shows top view photographs of different actuation modes of the 4D printed robot of FIG. 10b.

FIG. 10d is a graph of measured displacement of the 4D printed robot's actuation from FIG. 10c as a function of time.

FIG. 10e is a graph of measured speeds with different specific payloads of the 4D printed robot's actuation from FIG. 10c.

### DETAILED DESCRIPTION

The subject technology overcomes many of the prior art problems associated with 3D and 4D printing inks. The advantages, and other features of the systems and methods disclosed herein, will become more readily apparent to those having ordinary skill in the art from the following detailed description of certain preferred embodiments taken in conjunction with the drawings which set forth representative embodiments of the present invention. Like reference numerals are used herein to denote like parts. Further, words denoting orientation such as “upper”, “lower”, “distal”, and “proximate” are merely used to help describe the location of components with respect to one another. For example, an “upper” surface of a part is merely meant to describe a surface that is separate from the “lower” surface of that same part. No words denoting orientation are used to describe an absolute orientation (i.e. where an “upper” part must always at a higher elevation).

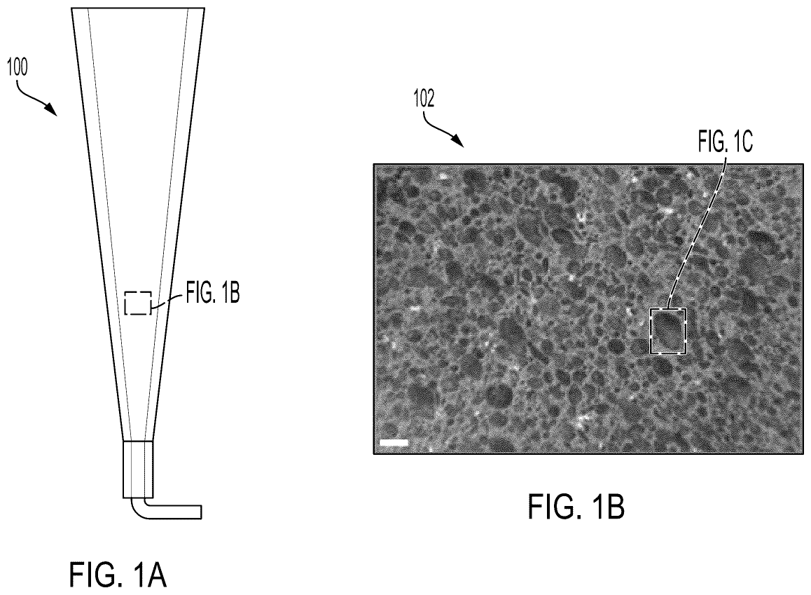

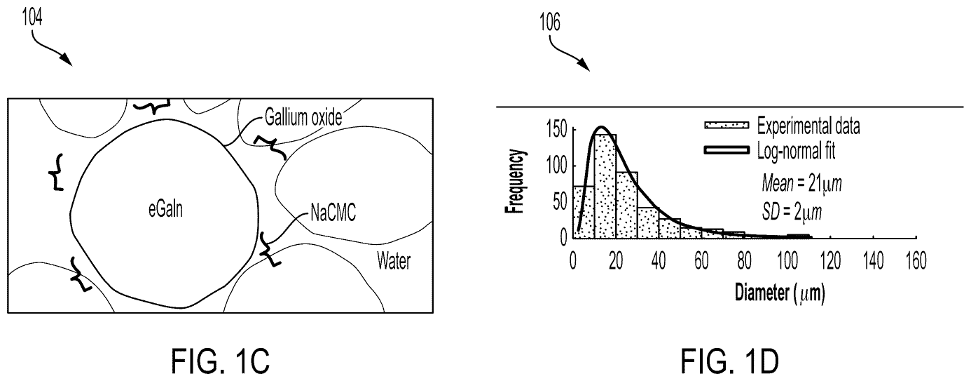

Referring generally to FIGS. 1a-5b, in at least one embodiment disclosed herein, an LM emulsion is comprised of eGaIn (5N Plus), NaCMC (MW≈250,000) (e.g. from Acros Organics) and deionized (DI) water (MilliQ). This can be created by first, making an initial bulk aqueous solution by mixing 5% NaCMC into deionized water using a dual asymmetric centrifugal mixer (e.g. SpeedMixer model DAC 150.1 FVZ-K, from FlackTek) at 3500 r/min in 5 min intervals until a homogeneous solution was obtained. Once homogeneity is obtained, 0.18 g of the bulk NaCMC solution is added to 0.06 g of DI water for further dilution, followed by an additional mixing step (3500 r/min, 2 min), resulting in a 3.75% w/w aqueous NaCMC solution. The LM emulsion is then created by adding 4.81 g of eGaIn to the aqueous NaCMC solution, followed by another shear mixing sequence (1750 r/min, 3 min; 3500 r/min, 15 min). The final composition of the resulting emulsion is 76.4% v/v eGaIn, 23% v/v water, and 0.6% v/v NaCMC. It should be understood that this is just one exemplary method of creating an LM emulsion, in accordance with the subject disclosure. The emulsion was then loaded into a 3 cc syringe and prepared for 3D printing.

In one example, a body ink (BI) was used to 3D print substrates for dogbones and an LED device. The BI was made of the two-part silicone Ecoflex 00-30 (Smooth-On) and fumed silica as a rheology modifier. Part A and part B were separately mixed with fumed silica as the mixing process generates heat, which affects the pot life of the polymeric mixture. First, part B was shear-mixed with 2% w/w of SloJo (Smooth On) for 1 min at 3500 r/min to increase the elastomer pot life. Then, 7% w/w fumed silica (e.g. Aerosil 150, Evonik) was added to part B as a rheology modifier, and shear-mixed for 4 min at 3500 r/min (in 1 min increments). Similarly, part A was shear-mixed with 7% w/w fumed silica for 4 min at 3500 r/min (in 1 min increments). Part A and part B were then mixed together for 1 min at 1750 r/min. The resulting elastomer was then loaded into a 10 cc syringe, centrifuged at 4000 r/min for 30 s and prepared for 3D printing. The elastomer used to package the devices was made of neat liquid Ecoflex 00-30 (Smooth-On) by shear-mixing equal masses of part A and part B together for 1 min at 1750 r/min. All materials were processed under ambient conditions. (Temperature: 23.8 C and Relative humidity: 44.4%), unless otherwise stated.

The aqueous NaCMC solution (3.75% w/w) was characterized at T=25° C. using a hybrid rheometer (e.g. TA Instruments Discovery HR-1 model) with a cone plate geometry (40 mm plate diameter, 1°, 28 μm working gap), as it guarantees a uniform shear rate across the sample. The cone plate geometry was covered by a closed chamber accessory (e.g. TA Instruments) to reduce the effect of evaporation during experiment. The emulsion was also characterized under the same temperature but using a parallel plate geometry (20 mm plate diameter, 1 mm working gap) covered by a closed chamber accessory. The working gap between the parallel plates is 10 times the size of the maximum particle size observed in the emulsion, as this is often recommended when using parallel plates geometry. To ensure a high humidity environment when characterizing the emulsion, 10 droplet of water were placed around the sample, inside the closed chamber. Before each test, both samples were pre-sheared at 1 s⁻¹ for 5 minutes followed by a 1 min equilibration step by letting it rest. To obtain the storage and loss modulus (G′, G″, respectively) for the NaCMC solution and the emulsion, the instrument was set to operate in amplitude sweep mode, where the angular frequency was set to 1.0 rad/s. The torque applied was logarithmically swept from 1.0×10⁻¹ μN·m to 5.0×10³ μN·m, with 20 points collected per decade. To obtain apparent viscosity, the instrument was set in flow sweep mode. The applied shear rates for each sample were logarithmically swept from 1.0×10⁻² s⁻¹ to 1.0×10³ s⁻¹ with 20 points collected per decade. For the emulsion, the shear rate sweep was conducted in the reverse order (i.e., from high to low: 1.0×10³ s⁻¹ to 1.0×10⁻² s⁻¹) to avoid the short-term transients during the viscoelastic solid to fluid transition, which could lead to noise at low shear rates.

The LM droplet size distribution was done using an image of the emulsion printed on a glass slide. The image was taken using a camera (e.g. UI-3590CP Rev. 2, IDS) connected to a miniature microscope lens system (e.g. InfiniTube FM-100, Infinity) and a 18 mm/2.00× lens (e.g. PL-Series, Infinity). To obtain the droplet size distribution, the raw image was uploaded to ImageJ, converted to black and white, and segmented to get a clear definition of each droplet in the emulsion. The data was then exported from ImageJ and analyzed using custom MATLAB code.

The inks were 3D printed using a custom gantry system (e.g. Aerotech). Both the emulsion ink and the substrate ink syringes were equipped with gauge 27 (ID=200 μm) smooth-flow nozzle (e.g. Nordson, EFD) for 3D printing. Ink extrusion was performed using a pressure controller (e.g. Ultimus V High Precision Dispenser, Nordson, EFD). The emulsion was extruded at a pressure of 13 psi, and the BI was extruded at a pressure of 74 psi using a high pressure dispensing tool (HP10 cc, Nordson, EFD). The print speed used for both inks was 40 mm/s. The custom print-paths used for multimaterial printing were written using open-source python libraries (e.g. Mecode), and loaded to the Aerotech controller (e.g. A3200, Aerotech) for print execution. For easy handling and removal, all devices and samples were printed on top of a Teflon-coated steel plate.

Mechanical characterization was done, with mechanical tensile testing performed using a uniaxial testing setup (e.g. Model 6800, Instron) on dogbones made following ASTM D638-14 standard. Tensile testing was done on 12 dogbones to characterize the mechanical properties of the different materials used for 3D printing the conductive composites. Of these 12 dogbones, three are made of the printed BI, emulsion features with wires (EW) and neat packaging material (NP) (BI+EW+NP). Three are made completely of the BI. Another three are made of both the BI and NP (BI+NP). The remaining three are made of the NP, made using a mold. The data was analyzed using custom MATLAB code.

Electromechanical characterization was performed. The dogbones were fabricated by first printing a base with walls using the BI. The base with walls was subsequently cured at 70 C for 30 min using an oven (e.g. HeraTherm, Thermo Scientific). The emulsion feature was then printed on top of the cured base to avoid perforations of the base when manually adding wires to the emulsion. The nominal length of the embedded emulsion feature was 14 mm, with a width of 1 mm and a thickness of 0.2 mm. After printing the emulsion, the 3D profile of the printed emulsion feature was measured with a laser profiler (e.g. LJ-X8080, Keysight). Two sensing wires were then manually added into the emulsion. Before adding the two wires, their electrical resistance was measured using a source meter (e.g. 2401A, Keithley) with a four-point probe (e.g. 5806, Keithley). Directly following the manual addition of sensing wires, the dogbones are then packaged and cured at room temperature for at least 4 h.

Electromechanical characterization consisted of recording electrical resistance data of dogbones as they were cyclically stretched. Dogbones were characterized at strains corresponding to 50%, 100%, 200%, 300% and 400% of the nominal printed emulsion feature length. Three dogbones were tested for each strain level. The stretching set-up consisted of two modified clamps (e.g. Three-way clamps, Bossey), with one mounted on the motion system bed, and one mounted on an independently controlled z-axis. Electrical resistance was measured using a source meter (e.g. 2401A, Keithley) with a four-point probe (e.g. 5806, Keithley). The electrical resistance from the wires was subtracted from the measured electrical resistance of the emulsion to obtain the resistance of the emulsion features. A custom python script was used to control the motion of a linear stage (e.g. ATS150, Aerotech), where the speed, travel distance, and number of cycles were used as inputs. An additional custom python script was used to collect and synchronize the linear stage position with the measured electrical resistance. The dogbones were cyclically stretched and relaxed at a rate of 15 mm/s for each of the five strains tested. The data collected was analyzed using custom MATLAB (Mathworks) code.

An LED array was also fabricated using multimaterial 3D printing, in accordance with the subject technology, which consisted of 20 surface mount LEDs (e.g. Red, 0603, Kingbright) connected in parallel. The LED device was fabricated by first printing a substrate layer with walls made of the BI, which was immediately cured at 70 C for 30 min using an oven. This was followed by printing the conductive traces with the emulsion ink. Droplets of the BI were then printed in the LEDs final location, which serve to adhere the LEDs to the substrate. The LEDs were then manually placed on top of the adhesive droplets, bridging the power and ground traces. The device was subsequently packaged, and defoamed for 1 h under vacuum to remove air bubbles. Finally, the device was cured at room temperature.

Referring now to FIGS. 1a-1d, various aspects of an exemplary LM emulsion are shown. FIG. 1a is a schematic showing a 3D printing of a continuous filament 100 of LM emulsion, in accordance with the subject disclosure. FIG. 1b is an optical microscope image 102 of the 3D printed emulsion sample 100, with the emulsion composition illustrated in image 104 of FIG. 1c. The droplet size distribution of the optical microscope image 104 is shown in the graph 106 of FIG. 1d. The average diameter of the LM droplets was found to be 21 μm±2 μm (95% confidence interval), obtained by fitting a log-normal distribution to droplet size distribution data. A log-normal distribution fit is used as it is known to accurately model right-skewed data. Right-skewed data is common in attrition processes to produce LM droplets, as it has been previously reported on other LM emulsions. The minimum droplet diameter observed was 7 μm, and the maximum droplet diameter was 120 μm. Although the maximum diameter is on the same order as the nozzle inner diameter (200 μm), the LM droplets do not clog the nozzle, likely due to the liquid nature and high compliance of the droplets.

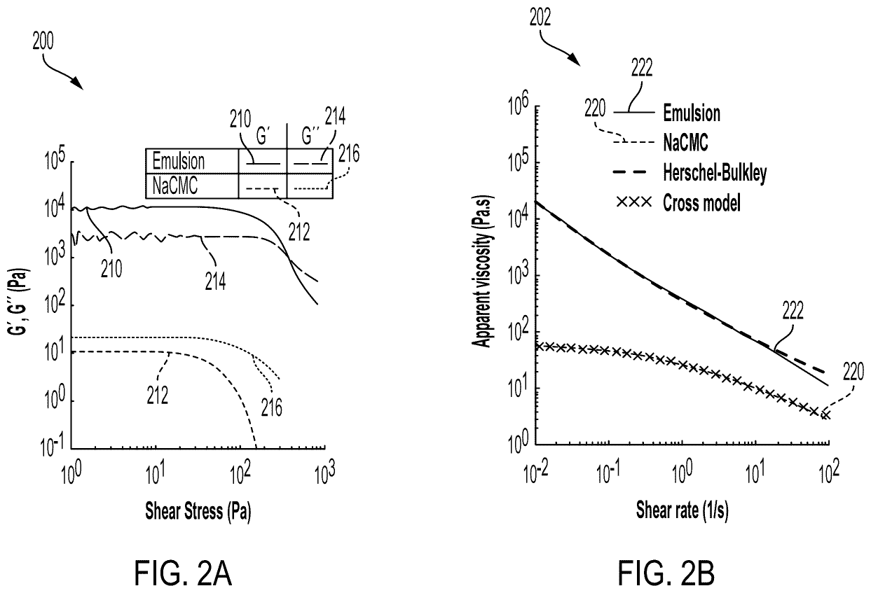

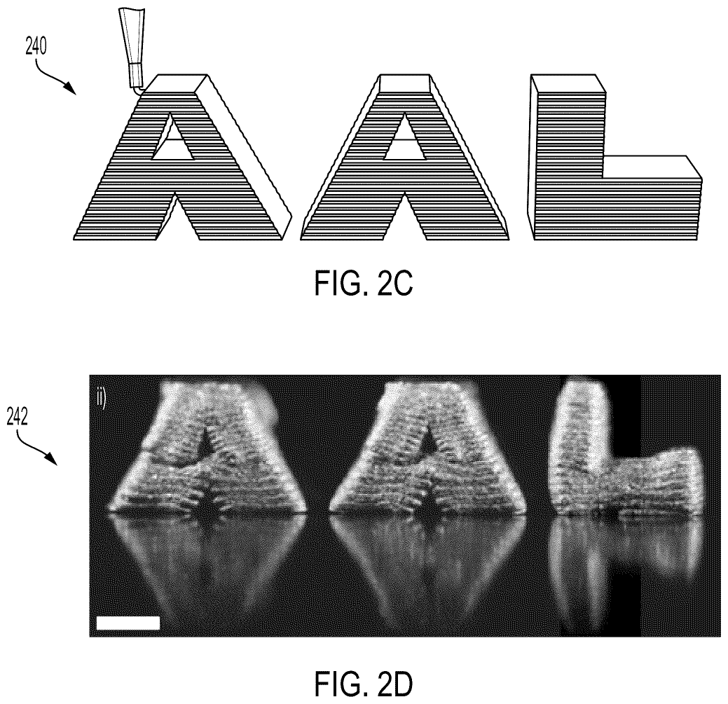

Referring now to FIGS. 2a-2b, the rheology of the materials described herein are discussed. The graphs 200, 202 therein show rheological data collected on the aqueous NaCMC solution (no eGaIn) and the NaCMC based LM emulsion. Oscillatory data collected on the aqueous NaCMC solution and the emulsion are presented in graph 200, which show the storage modulus (G′) and loss modulus (G″) in response to shear stress. The storage modulus is shown in solid lines, with 210 being the storage modulus for the emulsion, and 212 being the storage modulus for the NaCMC solution. The loss modulus is shown in dashed lines, with 214 being the loss modulus for the emulsion and 216 being the loss modulus for the NaCMC solution.

The aqueous NaCMC solution shows a higher loss modulus (G″) than storage modulus (G′) at the tested shear stress range, indicating that the NaCMC solution exhibits no yield stress and behaves more like a fluid than a solid. Given the fluid-like behavior and lack of a yield stress, the NaCMC solution alone cannot be used for 3D printing solid-like filaments. On the other hand, the emulsion shows an elastic behavior as its storage modulus (G′) remains higher than the loss modulus (G″) at low shear stresses, until shear yielding occurs and its behavior transitions to predominantly fluid-like at higher shear stresses. The elastic behavior of the LM emulsion at low shear stresses suggests that it can be used for 3D printing solid-like filaments capable of retaining their shape after nozzle extrusion. This observed behavior with our 76.4% v/v eGaIn emulsion is consistent with other observations on dense emulsions, which demonstrate that emulsions with a dispersed phase volume content above random close packing (i.e., 64% v/v) behave like solids due to the increased inter-droplet energy from droplet deformation as a result of being compressed.

FIG. 2b shows a graph 202 of data from flow sweep experiments where both the aqueous NaCMC solution (graph line 220) and the LM emulsion (graph line 222) exhibit shear thinning behavior, as viscosity decreases with increasing shear rate. The NaCMC solution shows a shear-thinning behavior, which is consistent with existing flow data for solutions with NaCMC concentrations ranging from 0.2-5.0 w %. The particular shear-thinning behavior of the aqueous NaCMC solution can be represented by the cross model. Eq. (1):

$${η}_{C r o s s} = \frac{{η}_{0} - {η}_{inf}}{1 + {( \dot{λ} \dot{γ} )}^{m}} + {η}_{inf}$$

where η_{cross} is the Cross-model viscosity, \dot{γ} is the shear rate, η₀ is the viscosity at zero shear rate, η_{inf} is the asymptotic viscosity at infinite shear rate, À is a time constant, and m is a dimensionless parameter which measures the viscosity dependence on shear rate in the shear thinning region. An m parameter of 0 denotes a Newtonian fluid, while an m that tends to one denotes an increasingly shear-thinning behavior. Fitting equation (1) using a Levenberg-Marquardt algorithm on MATLAB results in a zero shear rate viscosity (η₀) of 59.8±0.5 Pa·s (95% confidence interval), a nearly negligible high shear rate viscosity (η_{inf}) of 0.5±0.5 Pas, a time constant λ of 1.4±0.1 s, and a dimensionless m parameter of 0.62±0.02. The crosses on graph 202 depict a cross-model which accurately describes the shear-thinning behavior of the aqueous NaCMC solution. The shear-thinning of the aqueous NaCMC solution is likely due to polymer disentanglement.

On the other hand, once eGaIn is emulsified within the aqueous NaCMC solution, the emulsion presents a log-linear shear-thinning behavior with no Newtonian plateau, indicating the formation of an internal structure and presence of yield stress. This is consistent with the findings shown in graph 200, where shear yielding is observed. The emulsion (graph line 222) also shows a three order of magnitude increase in viscosity at low shear rates, when compared to the aqueous NaCMC solution (graph line 220).

To further characterize the printability of the emulsion, calculations of emulsion yield stress are performed. The yield stress for the emulsion is determined by fitting the Hershel-Bulkley model of apparent viscosity versus shear rate data, as shown in graph 202 (dotted lines). The Herschel-Bulkley model for apparent viscosity versus shear rate data is described by Eq. (2):

$${η}_{H B} = \frac{τ}{\dot{γ}} = {τ}_{γ} {\dot{γ}}^{- 1} = K {\dot{γ}}^{n - 1}$$

where η_{HB} is the Herschel-Bulkley model viscosity, τ is the shear stress, τ_{γ} is the yield stress, K is the consistency index, and n is the flow index. Fitting equation (2) on flow data using a Levenberg-Marquardt algorithm on MATLAB gives a consistency index K of 185.2±6.4 Pa·sⁿ (95% confidence interval), a flow index n of 0.47±0.03, and a yield stress of 184.2±2.3 Pa.

The utility of the emulsion was further assessed by evaluating the spanning distances of 3D printed structures. The method used herein calculates the minimum storage modulus needed to achieve a filament capable of spanning distances. The minimum storage modulus is given by Eq. (3):

$${G}_{min}^{′} = 1.4 {ρ}_{eff} g \frac{{d}^{4}}{{D}^{3 ′}}$$

where D is the filament diameter, dis the spanning distance of the filament, g is the gravitational constant, and ρ_{eff} is the effective density of the filament. This equation is derived by modelling a filament as a beam with a uniform weight distribution, where the maximum deflection is set to be 5% of D, as is known to those in the field. The minimum storage modulus obtained from equation (3) is then compared to the emulsion storage modulus to determine its maximum spanning distance. The emulsion storage modulus G′ is obtained from graph 200 of FIG. 2a when the shear stress tends to zero, giving approximately 9.9 kPa. Using equation (3), the emulsion ink is capable of printing 3D structures that span up to 0.95 mm between supports.

Referring now to FIGS. 2c-2d, to validate the utility of the emulsion ink for creating complex 3D structures capable of spanning distances, a self-standing structure with overhangs denoting the initials of our group “AAL” was 3D printed using the emulsion ink. A schematic 240 of the printing process for this 3D printed structure is represented in FIG. 2c. Image 242 of FIG. 2d is a photograph showing the self-standing 3D printed structure from the schematic 240 which includes overhangs and is mechanically stable. There are some distortions at the overhangs shown image 242, specifically, in the walls of the hollow sections of the ‘A’s, likely a result of de-formation of lower layers from the accumulated weight of subsequent layers. Increasing the yield stress of the emulsion would effectively improve the resolution of overhangs features such as the ones shown in image 242.

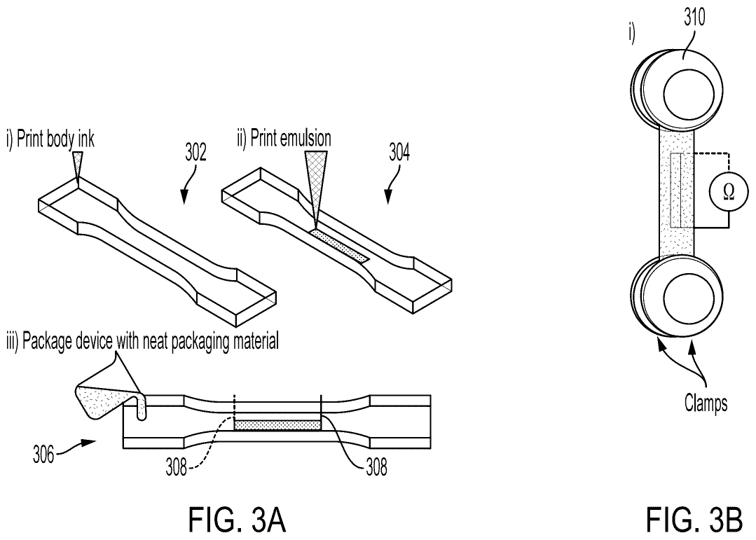

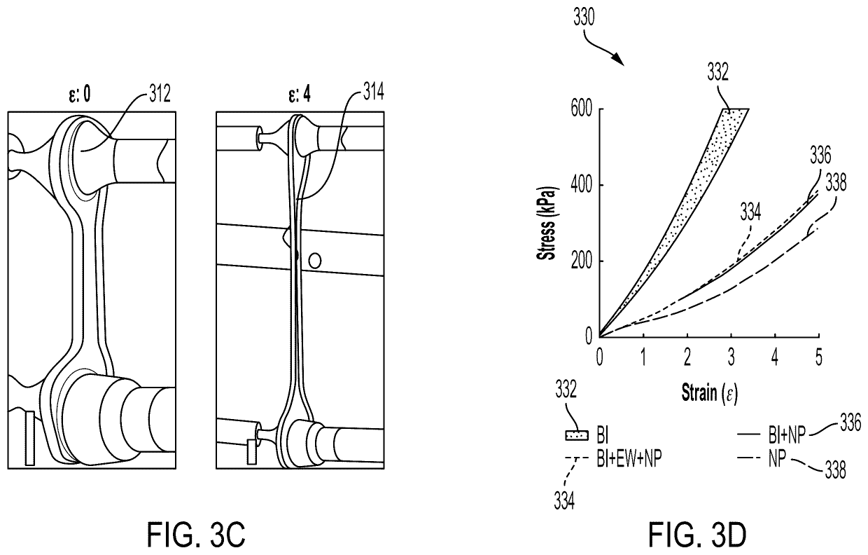

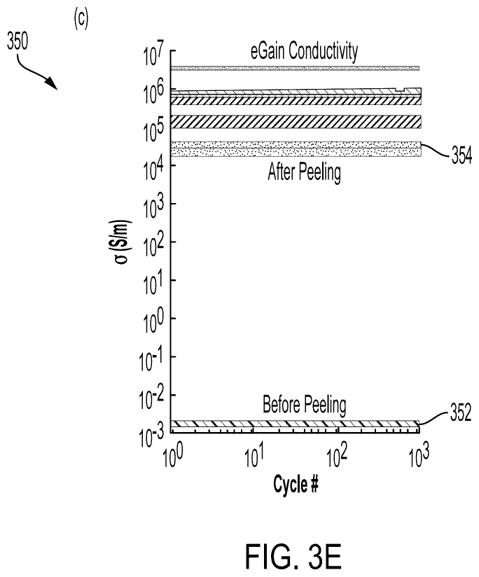

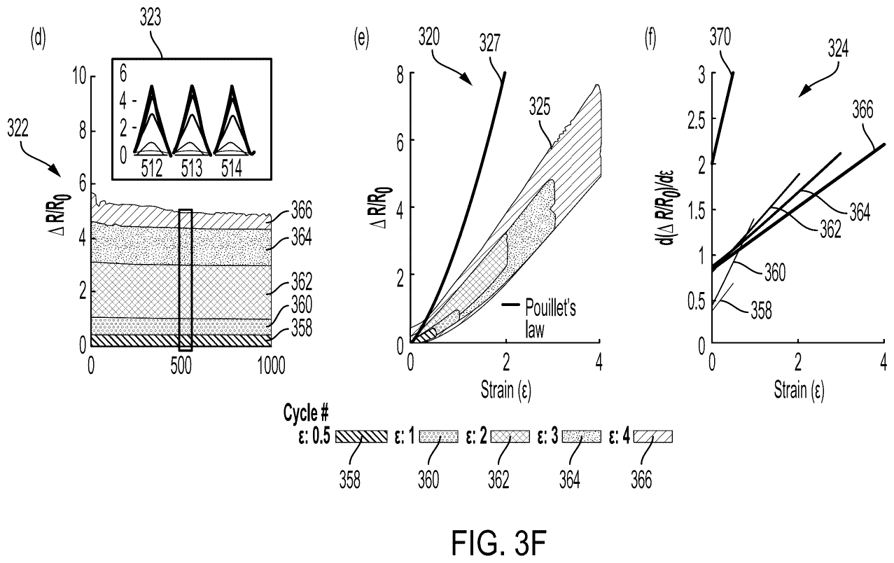

Referring now to FIGS. 3a-3f, the multimaterial printing process for the dogbones subjected to electromechanical characterization is shown. In particular, FIG. 3a shows steps of using the process and materials disclosed herein to print a dogbone. First, the base and walls of the dogbone are printed using a BI, as shown in image 302. Then, the emulsion is printed on top of the cured base layer, as shown in image 304. Lastly, as shown in image 306 two wires 308 were added to the printed trace, and the dogbone was packaged with Ecoflex 00-30.

The electromechanical characterization was conducted using the custom set-up shown in FIGS. 3b-3c where dogbones 310, 312, 314 were cyclically stretched at different strain levels. FIG. 3b shows a schematic representation of the dogbone 310 and stretching setup to be used for electromechanical characterization. The images in FIG. 3c show the dogbone 310 being stretched from an initial unstretched position (dogbone 312) to four times its original length (dogbone 314).

The graph 330 of FIG. 3d shows the engineering stress as a function of engineering strain of 12 dogbones, three made of body ink BI (332), three made of BI+wires (EW)+neat packing (NP) (334), three made of the BI+NP (336), and three made of NP (338). The dark lines denote the mean, and the shaded region denotes the standard deviation of the data. There are no notable differences between composites of the BI with the emulsion with BI+EW+NP (334) and those only comprised of the BI and NP (BI+NP) (336). These findings support the inclusion of LM droplets as allowing the host polymer to preserve its mechanical properties. On the other hand, dogbones made of only the BI (332) show a more elastic behavior with higher stiffness, while dogbones made of only the NP (338) exhibit a lower stiffness and a more pronounced hyperelastic region at higher strains. Although there are differences between the mechanical properties of BI and NP, this did not affect the electromechanical tests as no de-lamination was seen during any of the tests of BI+EW+NP, which indicates a strong adhesion between the packaging layer and the cured base and walls of the devices.

Referring now to FIGS. 3e-3f, to explore the electromechanical response of the dogbones with the emulsion features, samples were strained uniaxially to fracture the NaCMC and Ga₂O₃ that separate individual droplets, thereby forming highly conductive coalesced networks. Graph 350 shows the mean conductivity and standard deviation (SD) of dogbones tested at different strain levels, as well as their mean conductivity before and after peeling them off the Teflon substrate. The mean conductivity was calculated using the relaxed resistance (resistance after each cycle) and the cross-sectional area of the dogbones used in each group. Dogbones are not conductive right after packaging and curing, as seen in the lower shaded region 352 on graph 350. However, they exhibit a jump in conductivity when peeled from the substrate, with a mean conductivity of 2.87×10±S·m⁻¹ and an SD of ±1.10×10±S·m⁻¹, as seen in the top shaded region 354. Te highest after-peeling conductivity is around two orders of magnitude lower than that of bulk eGaIn, indicating a coalesced conductive network composed of a small fraction of the eGaIn droplets. It is important to note that although the samples were carefully peeled from the substrate, their conductivity is highly dependent on the amount of strain induced on the dogbones during the peeling process. This dependence on strain can explain the high SD for the dogbones after being removed from the substrate.

As shown in graph 350, the mean conductivity for samples activated at a strain of 50% was 1.61×10⁵ S·m⁻¹, with an SD of ±1.43×10³ S·m⁻¹. For samples activated at 100%, their mean conductivity was 5.53×10⁵ S·m−1±7.69×10³ S·m⁻¹. Samples activated at 200% had a mean conductivity of 7.04×10⁵ S·m−1=1.30×10±S·m⁻¹. The mean conductivity for samples activated at 300% was 7.50×10⁵ S·m−1±2.15×10±S·m⁻¹. Lastly, samples activated at 400% had a mean conductivity of 8.61×10⁵ S·m−1±4.78×10±S·m⁻¹. These results show that conductivity increases with higher strains, with a sharp increase after only 50% strain, and significant increase until a strain of 400%. Although straining the samples at 400% shows the highest conductivity, it also has the highest variation (SD). The observed increase in SD with increased strain could be caused by the deformation of the interface between the packaging material and the wires, which we observed completely separates for strains above 400%. Through this approach we achieve eGaIn composites exhibiting conductivities of up to 25% of the bulk LM, indicating a significant increase in the fraction of coalesced eGaIn droplets. Further increase in the fraction of coalesced eGaIn droplets may be inhibited by Ecoflex 00-30 infiltrating through part of the printed emulsion, thereby preventing activation of eGaIn droplets at the elastomer/emulsion interface. The maximum zero-strain conductivity achieved in this work is more than three times that of previous work on LM emulsions that mechanically sintered drop casted samples via axial strain. Revisiting the mechanical data for the dogbones 314 of FIG. 3c, the stress needed to coalesce the embedded emulsion can be as low as 25.21 kPa for 50% strain, 50.3 kPa for 100% strain, 109.9 kPa for 200% strain, 187.9 kPa for 300% strain, and 282.4 kPa for 400% strain. This is at least an order smaller than previous work on mechanically sintered LM emulsions. Smaller activation stresses allow for a larger range of compatible polymers, and activation protocols that do not risk mechanical failure.

As shown in graph 350, the conductivity of all samples reach a steady state after just one cycle for all applied strains. The packaged emulsion stability is demonstrated by its low variation of less than 6% SD for all strains. The packaged emulsion stability is further demonstrated in graph 322 of FIG. 3f, which shows the relative change in resistance (relative resistance divided by the zero-strain resistance, ΔR/R₀) as a function of cycle number, for all strain magnitudes tested. Similar to the conductivity after the first cycle, ΔR/R₀ has a sharp decrease after the first cycle for all strains tested, and remains consistent showing a repeatable behavior throughout 1000 cycles. The boxed insert 323 above graph 322 shows a magnified view of three cycles after approximately 500 cycles. From this insert it can be seen that the data is consistent from cycle to cycle, and as expected, the ΔR/R₀ is dependent on the applied strain.

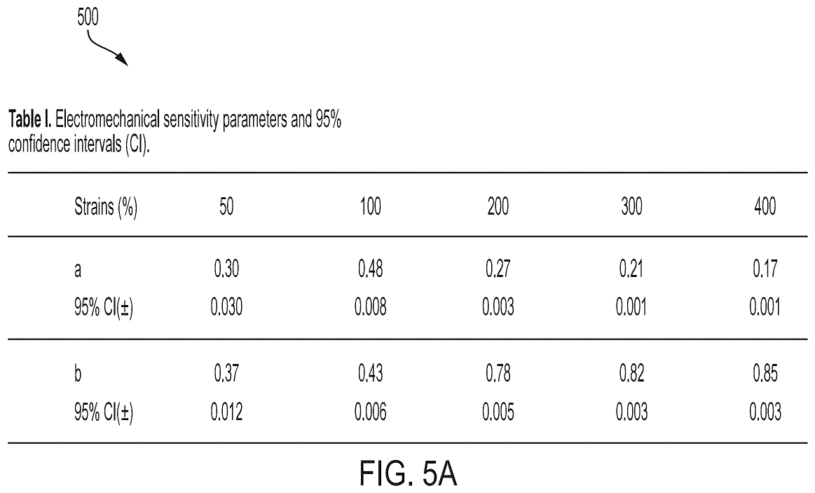

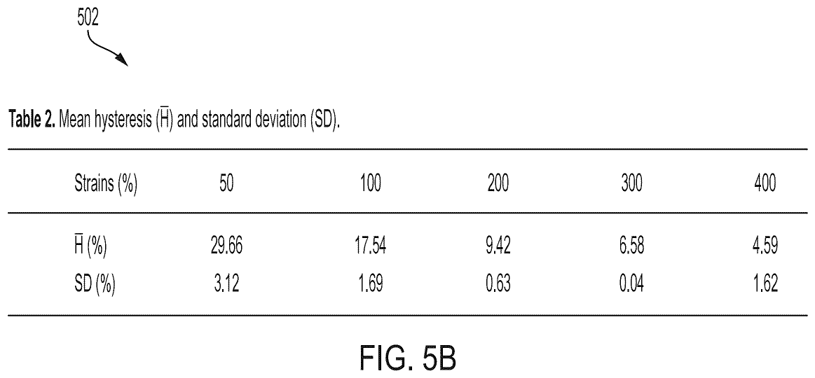

Graph 320 shows the ΔR/R₀ versus strain for all strain magnitudes tested, with each curve containing data for all 1000 cycles. The response of the emulsion ink (graph line 325) is compared to Pouillet's law (ΔR/R₀=ε²+2·ε) (graph line 327) which describes the ΔR/R₀ for a homogeneous incompressible elastic solid conductor. To evaluate the electromechanical sensitivity of the emulsion at the different strain levels, we first fit the ΔR/R₀ data of each strain level with a quadratic model using the Levenberg-Marquardt algorithm on MATLAB. The quadratic model is described by Eq. (4):

$$\frac{Δ R}{R 0} = a {ε}^{2} = b ε$$

where ε is the strain, and a and b are fitting parameters. The parameters of the quadratic model fit for each strain level tested are shown in table 500 of FIG. 5a. To quantitatively evaluate the electromechanical sensitivity of the emulsion at different strains, we calculated the slope of the quadratic model fitted to the cyclic data of each strain level. The slope of the quadratic model fit is obtained by taking the first derivative of equation (4) with respect to strain as Eq. (5):

$$\frac{d ( \frac{Δ R}{R 0} )}{d ( ε )} = 2 a ε + b$$

where equation (5) describes the electromechanical sensitivity as a function of strain.

Graph 324 shows the slope of each curve (360, 362, 364, 366) evaluated up to 400% strain. It can be seen that the emulsion electromechanical sensitivity is lower than the one described by Pouillet's law (370) throughout all strains. The emulsion activated at 50% strain (358) showed the lowest electromechanical sensitivity among all activation strains. Emulsions activated at 100% strain (360) show a slightly higher electromechanical sensitivity. The electromechanical sensitivity of the emulsions activated at strains of 200% (362), 300% (364), and 400% (366) is similar at low strains, with the sensitivity being slightly higher with higher activation strains. However, at strains of 35% the three curves intersect, and after this point the emulsions activated at 200% strain show a slightly higher electromechanical sensitivity, closely followed by emulsions activated at 300% strain, and 400% strain. The low electromechanical sensitivity throughout all strains tested can be explained by the tortuosity of conductive pathways within the LM coalesced network. These tortuous conductive pathways are formed when eGaIn droplets rupture and connect with each other, creating pathways of different geometries throughout the network. The lower electromechanical sensitivity within these pathways could be explained by the hydrostatic pressure on the eGaIn droplets as samples are stretched, which causes the interconnecting area between droplets to enlarge. The spatial arrangement of interconnected droplets also plays a major role on the electromechanical response. Low electromechanical sensitivity in stretchable electronics allows for the creation of wiring or sensors that can be used both at a relaxed state and a stretched state without losing functionality. Higher electromechanical coupling is more desirable when creating strain sensors where response depends on the applied strain.

Measures of the hysteresis for the data displayed in graph 320 are shown in table 502 of FIG. 5b, in where H is the mean hysteresis. Hysteresis was calculated for all 1000 strain cycles, and the reported mean hysteresis corresponds to the mean hysteresis of the three dogbones tested per strain level. As seen from table 502, dogbones activated at 50% strain show the highest mean hysteresis, which gradually decreases until reaching a minimum mean hysteresis at strains of 400%. The SD of each strain level is also shown in table 502. Similar to H, the highest SD is obtained with 50% strain, gradually decreasing for larger strains. The high hysteresis at low strains could be caused by the separating materials that keep the sparse LM networks from fully coalescing at low strains, as the NaCMC is known to have a slow recovery time at low concentrations (3.75%).

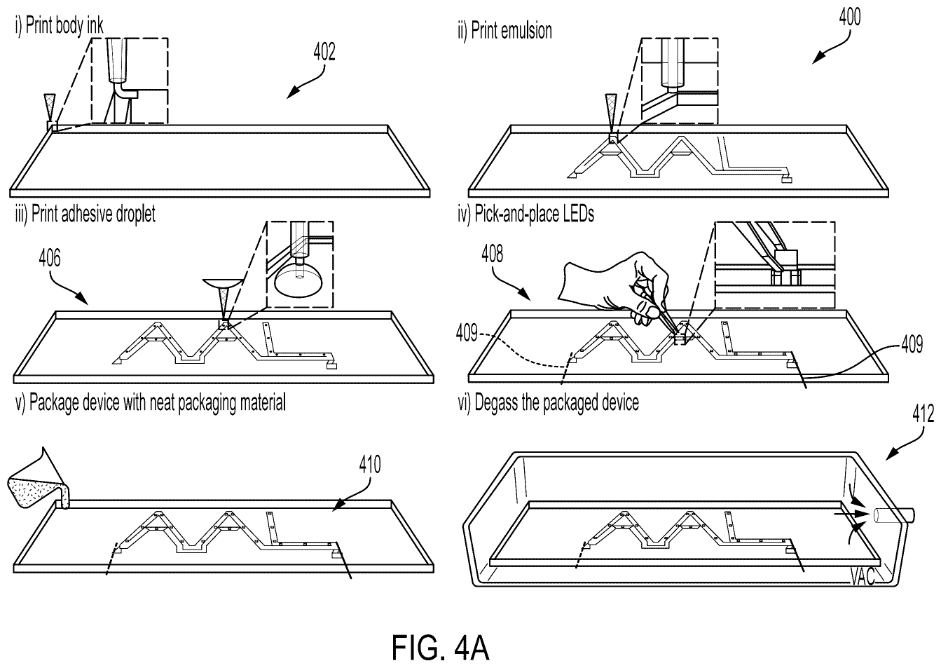

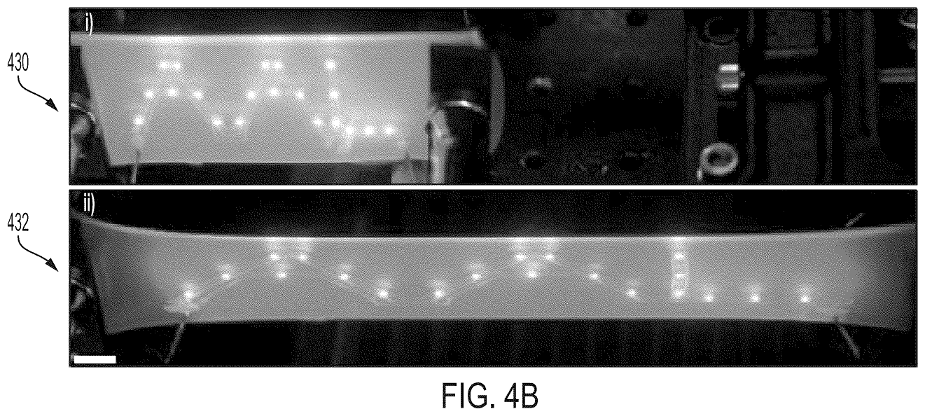

Referring now to FIGS. 4a-4b, to showcase the utility of the emulsion ink, a 3D printed stretchable array of LEDs spelling our lab initials “AAL” was fabricated. The steps for fabricating the stretchable array of LEDs is shown in FIG. 4a. In particular, first the substrate, including base and walls, are printed with a body ink, as depicted by image 402. Next, power and group traces are printed on top of the cured base layer with the emulsion, as depicted by image 404. Then, as depicted by image 406, a droplet of adhesive (BI) is then printed on top of the base layer between the traces. Then, as shown in image 408, LEDs are manually placed on top of each adhesive droplet (e.g., using tweezers) and wires 409 are then placed on the ground and power ends. At image 410, the device is packaged with neat packaging (e.g. Ecoflex 00-30). At image 412, the packaged device is degassed before it cures. It should be understood that while this this method is described to create a stretchable LED, this method could also be implemented as part of any other electronic circuit or device, as would be understood by those of skill in the art. Similarly, other electronic components besides LEDs could affixed to the adhesive and electrically connected to the traces as discussed herein, as part of the electronic device.

Referring now to FIG. 4b, images of the activated LED are shown, with image 430 depicting the LED device in an unstretched state and image 432 depicting the LED device after stretching to 200% of its normal length. To activate the LED device, it was mounted on linear axis stage for stretching, and connected to a power source (e.g. E36233 A, Keysight). Once connected, the device was stretched until it became permanently conductive and all LED's light up. Some LEDs started to light up at a strain of 80%, but only became fully activated at a strain of approximately 110%, where all LEDs light up. Once activated, the LED device remains conductive at both its relaxed state (430), and when stretched to 200% (432).

As such, the ternary liquid metal emulsion disclosed herein has a rheology that is compatible with 3D DIW, and shows high strain-induced conductivity at low stresses. Once synthesized, the emulsion displays a rheology capable of 3D printing self-supported complex 3D structures with overhangs. Upon packaging, the emulsion was shown to be electrically conductive by axial strains, with a maxi-mum conductivity and activation stress that is three times larger and an order of magnitude smaller, respectively, compared to previous work. The emulsion ink also exhibits outstanding electrical stability, with consistent conductivity after just one cycle, and low variation (<6% SD) over at least 1000 cycles. Once electrically activated, the ink exhibits low electromechanical sensitivity throughout all tested strains. The emulsion also demonstrated low hysteresis at high strains, with a higher hysteresis at lower strains. The utility of the emulsion ink was demonstrated by fabricating a strain-activated LED array device using a single multimaterial 3D printing process. The ease of fabrication, high conductivity, stability, and low hysteresis of our LM emulsion presents an opportunity for scalable and high throughput manufacturing of stretchable electronics.

Further, as discussed above, 4D printing is an emerging field where 3D printing techniques are used to pattern stimuli-responsive materials to create morphing structures, with time serving as the fourth dimension. However, current materials utilized for 4D printing are typically soft, exhibiting an elastic modulus (I) range of 10⁻⁴ to 10 MPa during shape change. This restricts the scalability, actuation stress, and load-bearing capabilities of the resulting structures.

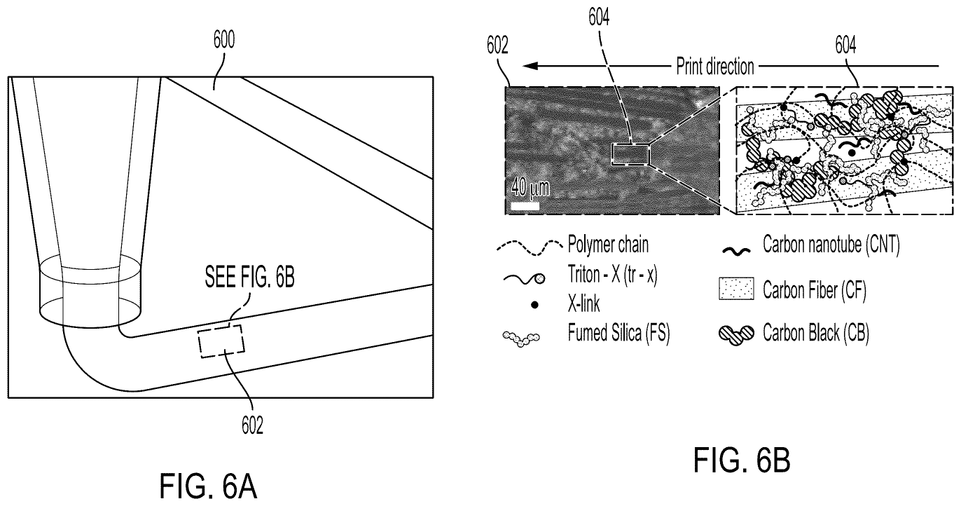

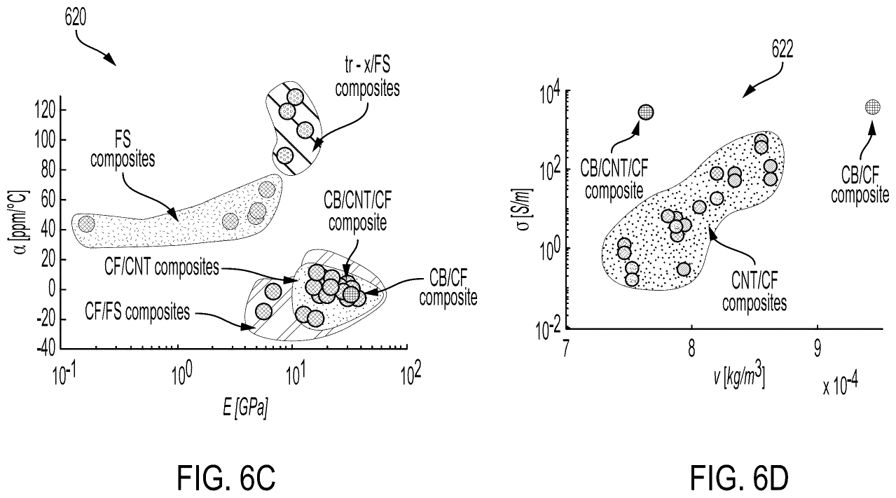

Referring now to FIGS. 6a-6d, to overcome the presented limitations on the E and localized and addressable actuation, introduced herein are multiscale heterogeneous polymer composites of novel category of stiff, electrically controllable 4D printed materials. FIG. 6a shows an example of once such material, in the form of a schematic of a 4D printed filament 600. FIG. 6b shows an SEM image 602 of part of the filament 600, with the representative notional schematic of all ingredients employed in the development of these heterogenous polymer composites shown in image 604. FIG. 6c is a graph 620 of the range of achievable α and E for the composite inks, while FIG. 6d is a graph 622 of the range of achievable σ and v for the composite inks disclosed herein.

These composites are called heterogeneous because they contain a plurality of ingredients, including a polymer matrix with an adjustable cross-link density, and a variety isotropic and anisotropic nanoscale and microscale fillers to achieve targeted resulting properties. Leveraging this platform, disclosed herein are a set of 37 inks covering a broad range of negative and positive linear coefficients of thermal expansion (−19.1±0.3-128.8±1.2 ppm ° C.⁻¹) (graph 620). This set of inks exhibits an E range that is four orders of magnitude greater than that of existing 4D printed materials (0.34±0.1-38.6±1.4 GPa) (graph 620) and offer tunable electrical conductivities (0.7±0.1-3.5×10³±9.9 Sm⁻¹) (graph 622) for simultaneous Joule heating actuation and self-sensing capabilities, all while maintaining comparable thermal responsiveness to the state of the art (graph 620). Utilizing electrically controllable bilayers as building blocks, we design and print a flat geometry that changes shape into a 3D self-standing lifting robot, setting new records for lifting capabilities (˜888 times its own weight) and actuation stress (˜6 MPa) when compared to other 3D printed actuators. We integrate this lifting robot with a closed-loop control system, achieving autoregulated actuation exhibiting a 4.8% overshoot and 0.8% undershoot, while effectively rejecting disturbances of up to 170 times the robot's weight, thereby establishing a new record in performance. Furthermore, we employ our ink palette to create, and 3D print planar lattice structures that transform into various self-supporting complex 3D surfaces. Ultimately, we employ our new ink palette to achieve a 4D printed electrically controlled multigait crawling robotic lattice structure equipped with electroadhesive feet, highlighting its capacity to transport loads up to 144 times its own weight.

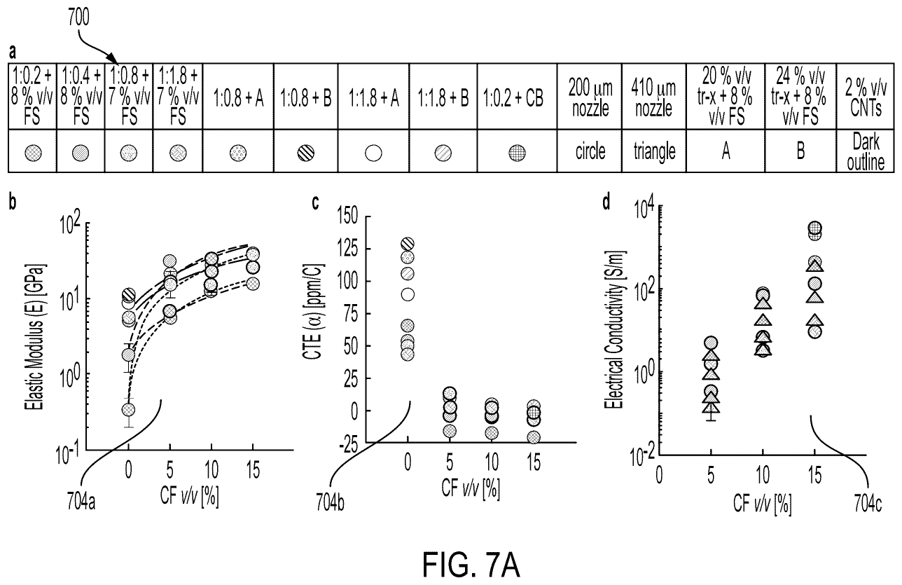

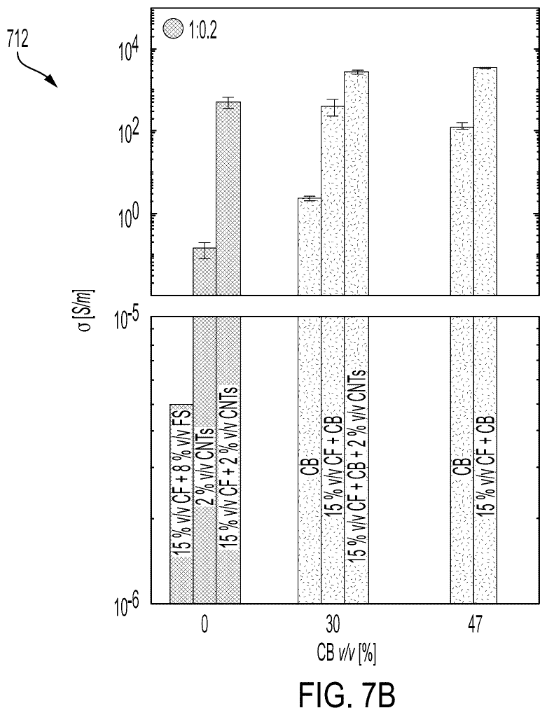

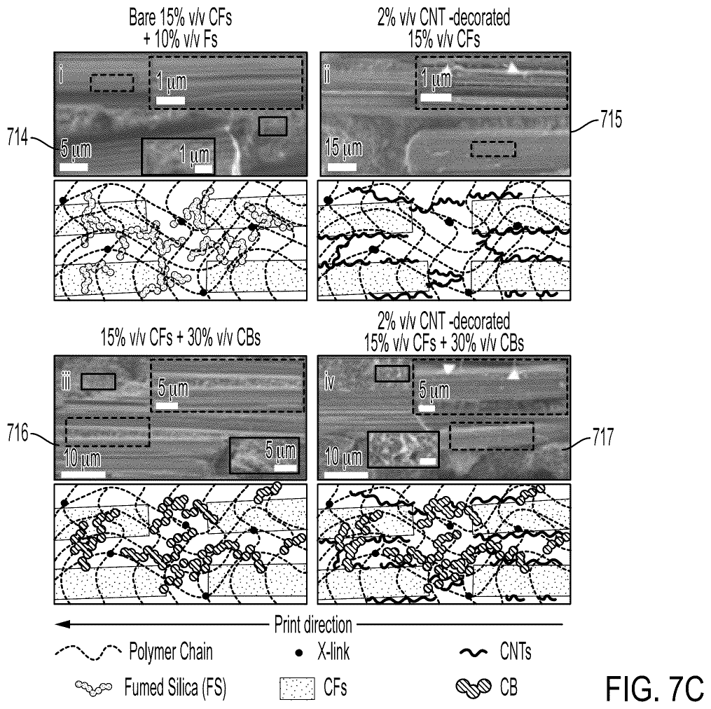

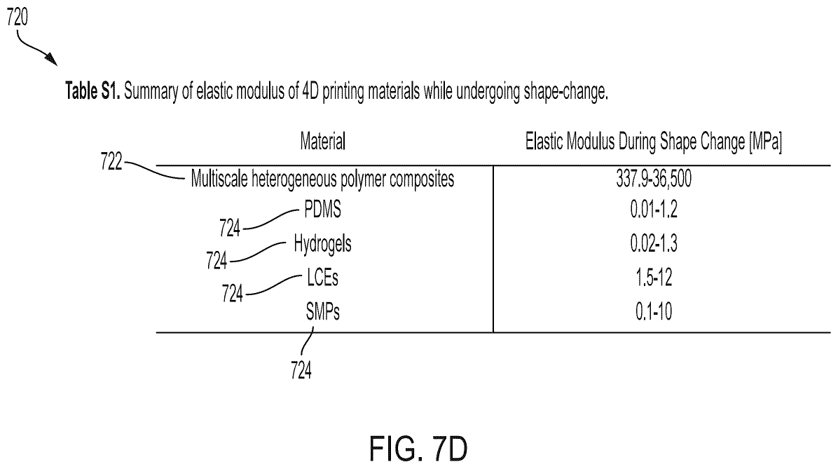

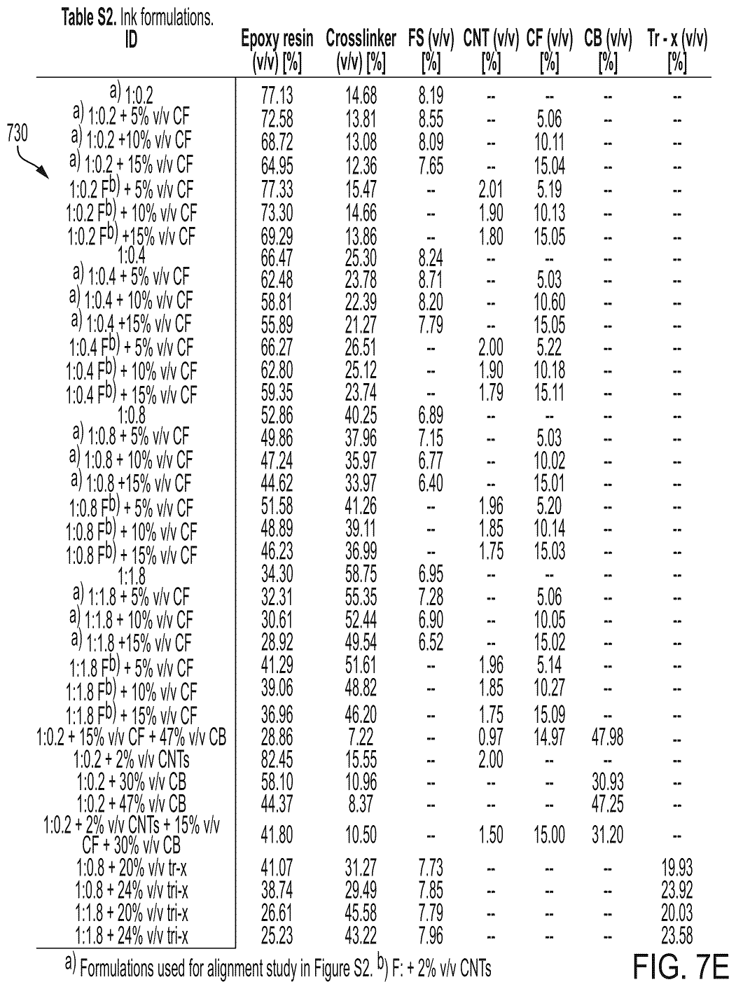

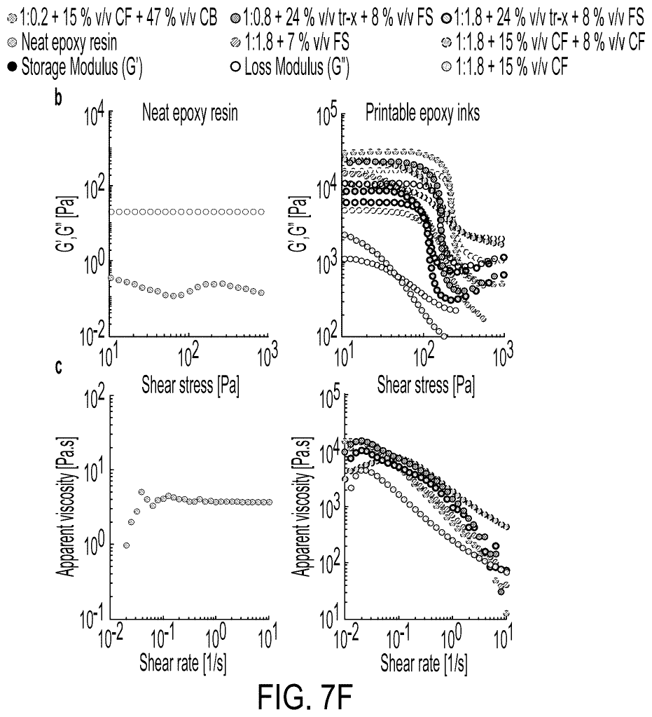

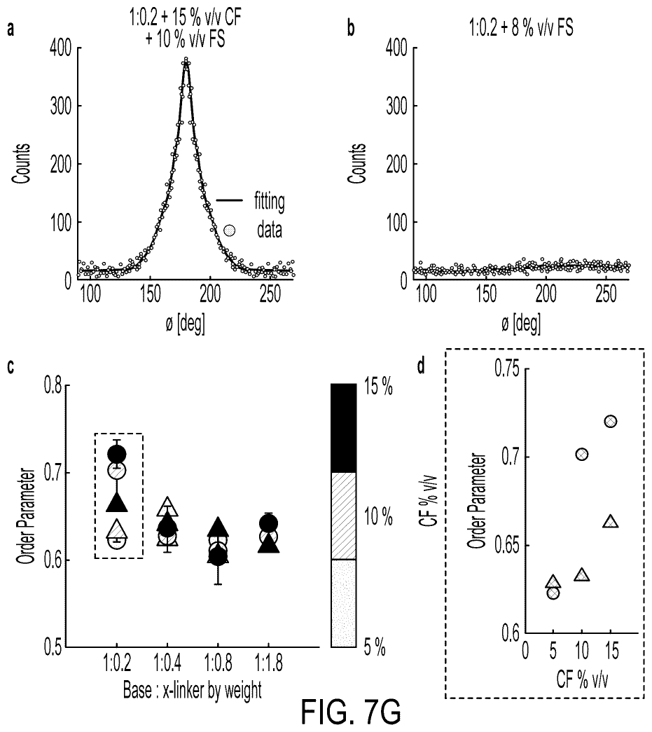

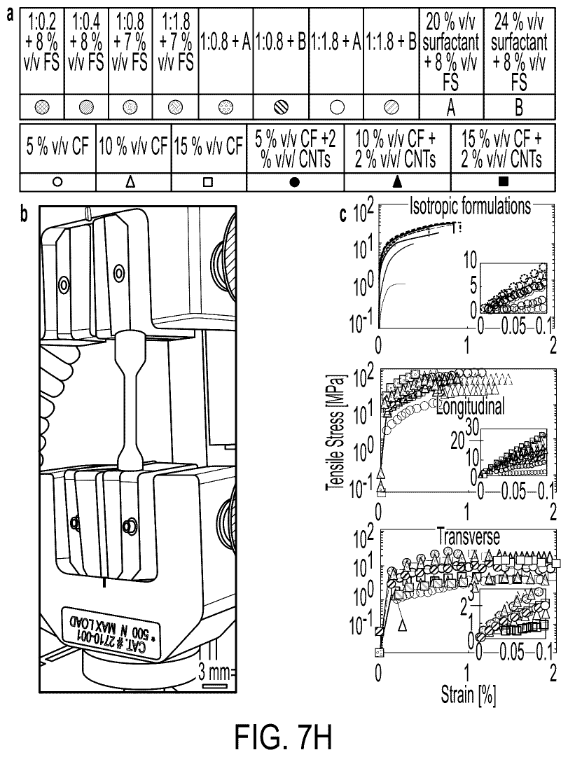

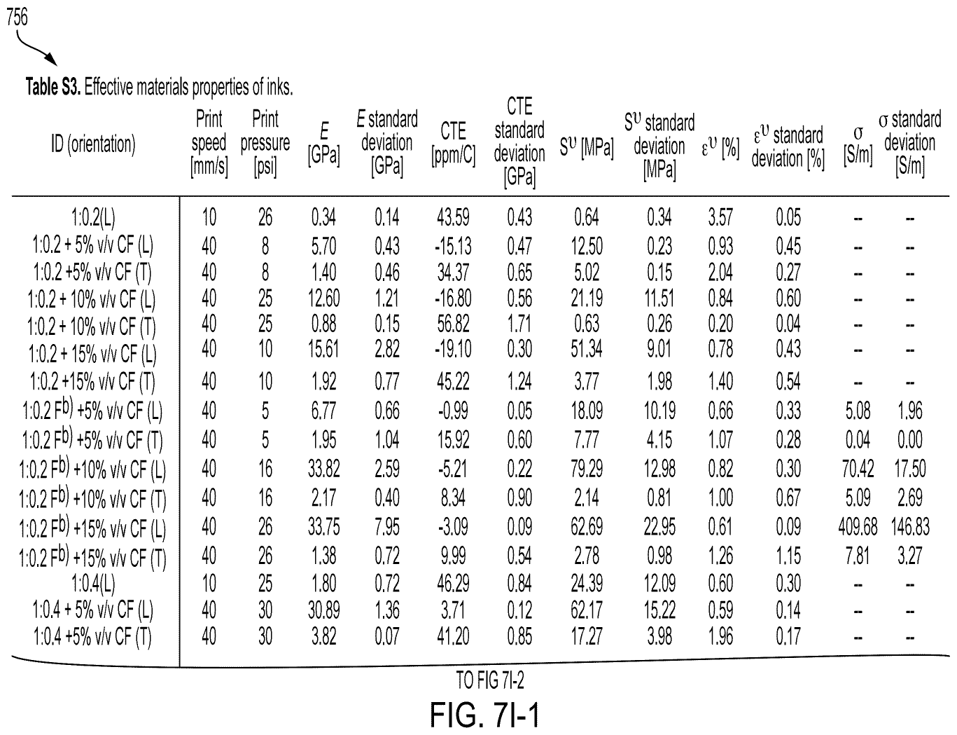

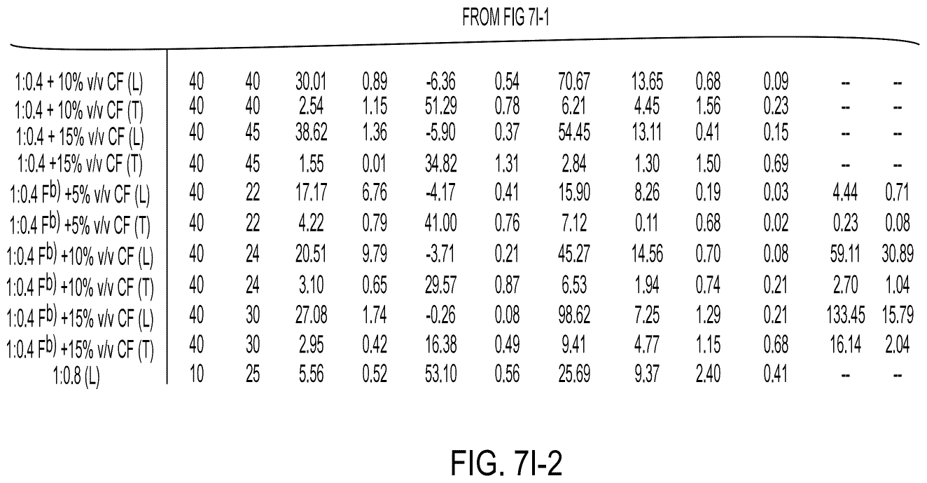

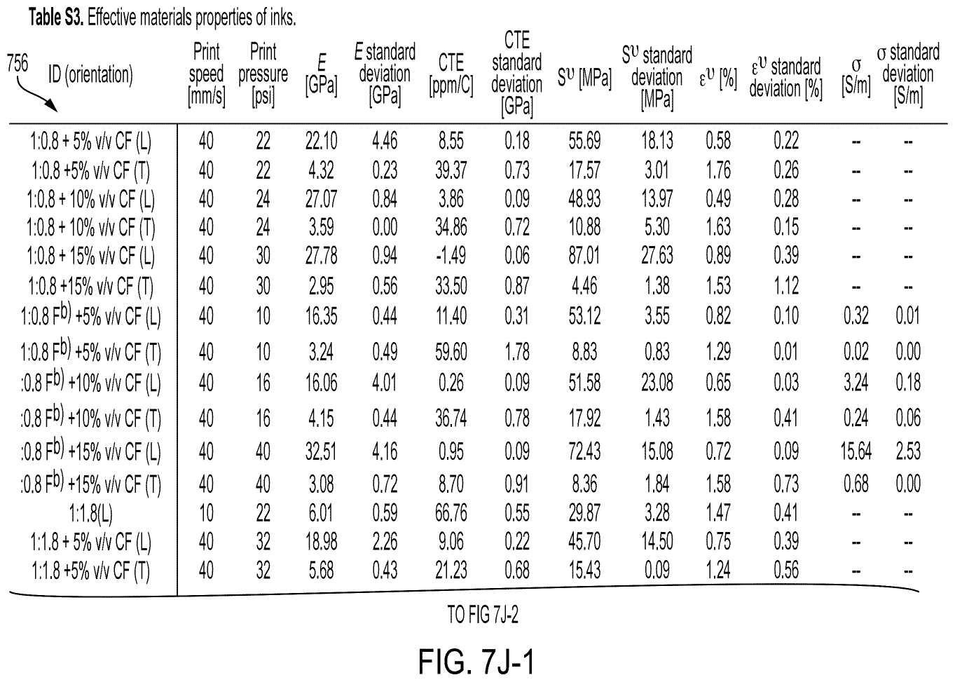

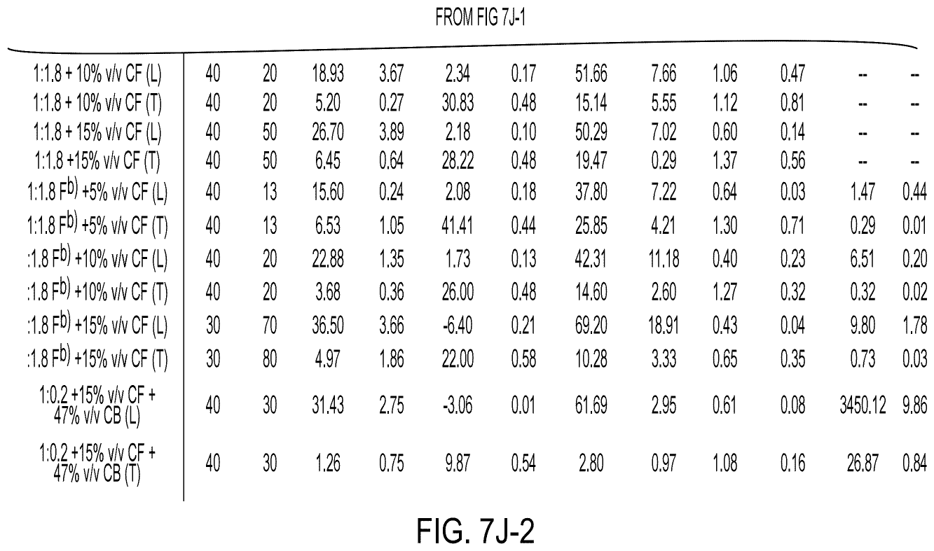

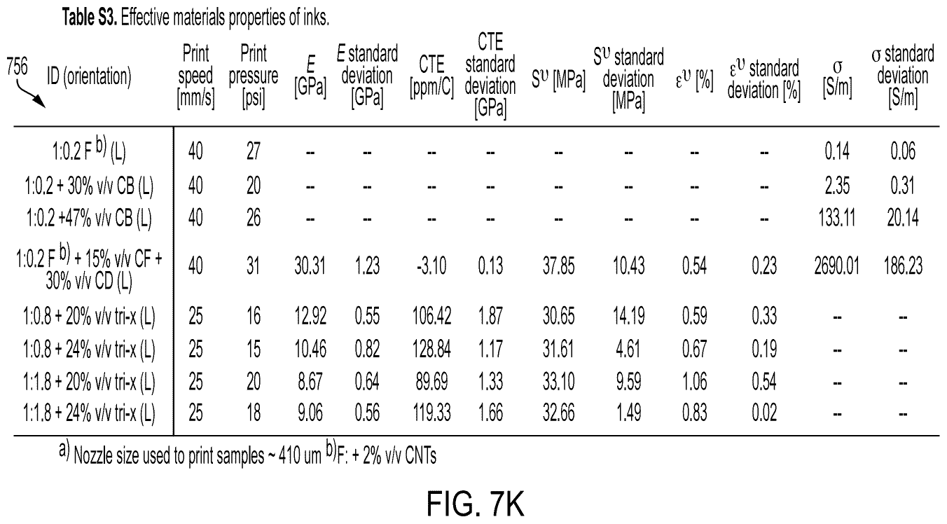

Referring now to FIGS. 7a-7k, various inks designed herein are disclosed. FIG. 7d shows a table 720 summarizing the E of 4D printing materials while undergoing shape-change. In particular, a multiscale heterogeneous polymer composite 722, designed in accordance with this disclosure, shows a much higher elastic modulus than other materials 724. FIG. 7e shows a table 730 of exemplary ink formulations in accordance with the subject disclosure.

In at least one aspect, the ink design herein starts with a cycloaliphatic epoxy resin, a thermoset that exhibits a large range of operating temperature (−62 C-288° C.), high elastic modulus (˜5 GPa), positive a (˜40 ppm ° C.), and low electrical conductivity (<10⁻¹² Sm⁻¹). This epoxy system was chosen since it can be polymerized at high temperatures (up to 250° C.), allowing us to use ambient cooling to achieve 3D morphing from flat printed structures. FIG. 7a shows a table 700 of tunable material parameters used to synthesize these inks. To develop inks with tunable stiffness and thermal expansion suitable for direct ink writing (DIW) (i.e., as seen in FIG. 7f, a shear-yielding stress, shear-thinning response, and plateau storage modulus), we start by adding different volume fractions (5-15% v/v) of carbon fibers (CFs), that preferentially align along the print direction due to the shear induced by the nozzle while printing (see FIGS. 7b and 7e). Additionally, carbon nanotubes (CNTs) were added to further improve E, α, rheological, and electrical properties. To further tune the rheological and electrical properties of the composite inks, we included carbon black (CB) ranging from 30%-47% v/v. Fumed silica (FS) was added to the formulations that do not included CB or CNTs (9-12% v/v), solely as a means of tuning the rheological properties to be compatible with DIW. Moreover, as additional means of tuning E and α, we vary the cross-linker to base to weight ratio within the epoxy matrix. Finally, we explored different concentrations of non-ionic surfactant (Triton-x (tr-x)), as means of increasing the α and E. Formulations of exemplary inks are shown in table 730 of FIG. 7e.

FIGS. 7a-7c show the results on the tunable E, α, and σ along the print direction. Characterization of heterogeneous epoxy composites. Table 700 is a legend for different ingredients and process parameters considered in the study (colon notation represents base to cross-linker ratio by weight). Graph 706 shows measured E along the print direction of different ink formulations as function of CF volume fraction with dotted lines corresponding to the results from the micromechanical model. Graph 708 shows measured α along the print direction of different ink formulations as function of CF volume fraction. Graph 710 shows measured σ along the print direction of different ink formulations as function of CF volume fraction. Graph 712 shows measured σ along the print direction for different carbon filler combinations as function of CB volume fraction with a fixed base:cross-linker ratio of 1:0.2 by weight. SEM images of different carbon filler combinations (714) and corresponding schematic (716) showing the multiscale interactions of the fillers and cross-links. Arrows in SEMs indicate locations of CNTs on the CF surfaces and CBs in the epoxy matrix.

First, we observe a minimal effect on E, α, and σ due to the inclusions of FS on the different cross-linker to base weight ratio formulations that do not contain CB or CNTs. However, these FS inclusions impart rheological properties suitable for DIW. Furthermore, we observe an increase on E and α as we added concentrations of tr-x (Graphs 704a 704b), which has been shown to act as a plasticizer into an epoxy matrix. Recent work has shown that in concentrations lower than 30% v/v, antiplasticization occurs, resulting in a slight improvement on E of the polymer, which is attributed to a suppression of the glassy state mobility. The presence of surfactant in the polymer also slightly reduces T_{g}, leading to a generation of excess free volume, which in turn increases a. There is a significant improvement on the composite elastic modulus as we increase the content of CFs (See FIG. 7a, graph 704a) due to the highly aligned networks of CFs along the print direction (see FIGS. 7g and 7h). The Halpin-Tsai micromechanical model was used to predict the improvement on E due to the contributions of these CFs fillers (dotted lines in on graph 704a), where there is good agreement within the experimental data and the models. Additionally, we tested the effects of different temperatures on E for a subset of composites that represent the different formulations (tr-x/FS and CB/C Composite). The study shows that there is negligible effect on E as we increase the temperature up to ˜160° C.

Graph 704b of FIG. 7a shows the effect of changing the CF content on the tunable α along the print direction. A tremendous decrease in α is observed as the volume fraction of CFs increase, even reaching low negative values (−19±0.3 ppm ° C.⁻¹), indicating that the material shrinks as the temperature increases. The average α of the CFs used in this work is −0.5 ppm ° C.⁻¹, which is about 40× bigger than the lowest measured α of our composites. Prior work with carbon fillers has shown similar results in which the measured α is orders of magnitudes smaller than the average α of the constituent carbon filler, where this effect is attributed to relative movements between individual fillers due to the internal compression generated by heating. Another factor contributing to the discrepancy of the α values between constituents and composite, is the effect of cross-linking densities on the samples. High cross-linking densities of an epoxy matrix restrict the relative movement of the fillers, thus increasing the effective α of the sample, while low cross-linking densities of an epoxy matrix allow for higher relative movement of the fillers, hence reducing the effective α of the sample.

Adding CNTs does not strongly affect E and α (outlined data points in graphs 704a and 704b), but we observe a significant increase in σ as we add constant CNTs inclusions of 2% v/v (graph 704c). As an additional means of further tuning σ, we found that reducing the nozzle size (triangle markers˜200 μm, circle markers˜410 μm), yields an increase in σ of ˜70% due to the enhanced degree of alignment of the carbon fibers (FIG. 7g). Moreover, we observe that the improvement in σ was more noticeable as the ratio between base to cross-linker weight ratio was lower, since the absence of cross-links allows for more conductive pathways to be formed with the carbon fillers. A summary of the resulting E, α, ultimate stress (S^{u}), and strain to failure (ϵ^{u}) for longitudinal and transverse print directions is shown in table 756 of FIG. 7I-J.

Based upon the strong dependence of σ on the inclusion of different carbon fillers, we decided to systematically investigate these effects. We fixed the base to cross-linker ratio to the lowest value (1:0.2) (graph 712), where the dependence was the highest. We included CB as a filler because of its ability to simultaneously tailor rheology and enhance σ. First, we consider the effects of the individual carbon fillers where CF formulations on its own are not electrically conductive. However, including only CNTs at a low concentration (2% v/v) results in a significant enhancement (more than five orders of magnitude) of σ. Combining 2% v/v CNTs with 15% v/v CF yields an even further improvement (3-4 orders of magnitude compared to CNTs only) on σ. Replacing the 2% v/v CNT formulations with 30% v/v CB yields a similar improvement on σ. Furthermore, we combined 30% v/v of CB with the 15% v/v CFs formulation and the 2% v/v CNTs+15% v/v CFs formulation, respectively, and we found an increase of ˜5× on σ compared to either the 2% v/v CNTs+15% v/v CFs or the 30% v/v CB+15% v/v CFs formulations. Finally, we evaluate combinations of the maximum allowable concentration (47% v/v) of CB and found that 15% v/v CFs+47% v/v CB yield a slightly higher σ (˜7× compared to 2% v/v CNTs+15% v/v CFs or 30% v/v CB+15% v/v CFs formulations) while not affecting E and α, nor the printability. On the contrary, a 15% v/v CFs+2% v/v CNTs+47% v/v CB formulation resulted in a non-printable ink, exhibiting repeated nozzle clogging.

Based on these results, we picture a composite microstructure where the electrical percolation of CF is blocked by the cross-links of the epoxy due to the large size of the CFs relative to the spacing between cross-links (714 of FIG. 7C). Loading the composite with nanoscale carbon fillers, such as CNTs or CB, enables electrical percolation as these fillers are small enough to form networks between cross-links. By adding CFs to these nanocomposites and aligning them by the printing process, we achieve a synergistic effect where the CNTs and CB provide percolation bridges between neighboring aligned CFs (images 715 and 716, respectively), resulting in a large multiscale percolation network, and an order of magnitude increase of σ. Including both nanoscale fillers and CFs can further increase percolation (image 717), which further increases σ by around a factor of 2. A similar type of increase of σ can be achieved by adding more of a single nano-filler, as seen in the 47% v/v CB+15% v/v CFs formulation. This micro-structure concept is further supported by prior related work on carbon composites. A summary of the resulting σ for longitudinal and transverse print directions is listed in table 756 of FIGS. 7i-7k.

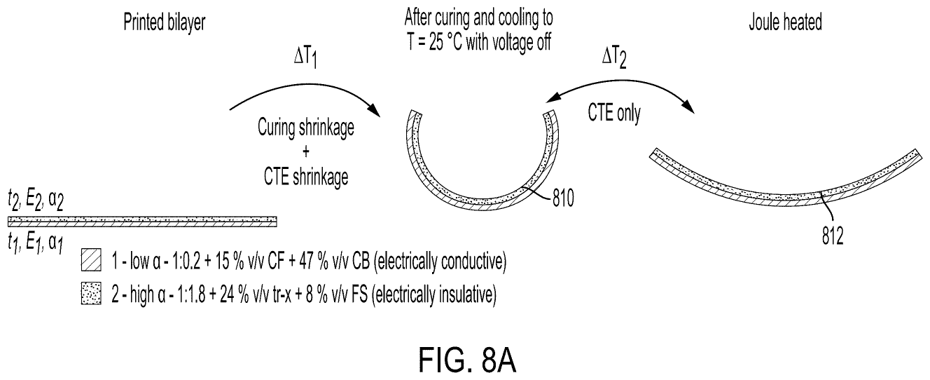

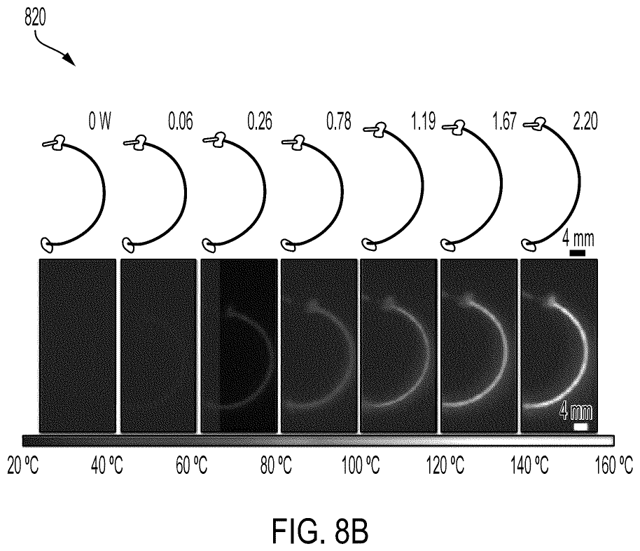

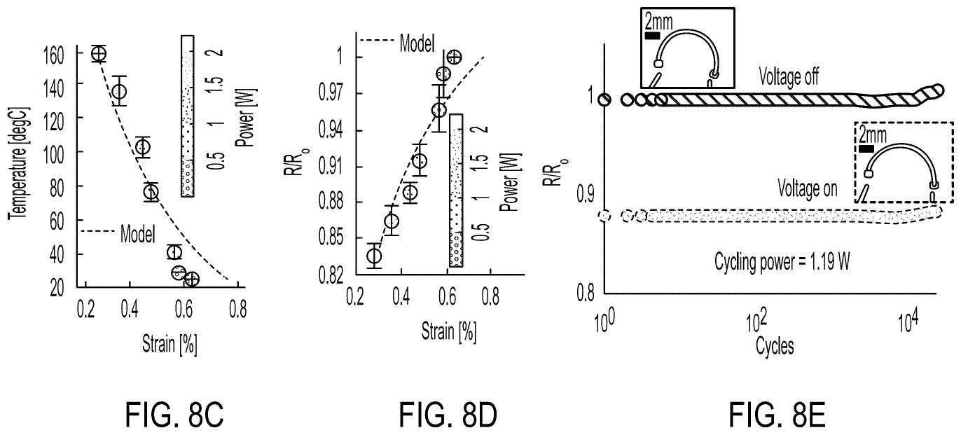

Referring now to FIGS. 8a-8e yo demonstrate the utility of our epoxy composite inks, we used multi-material 4D printing to first create simple bilayers, the basic functional unit across all our structures. The curvature responses of these bilayers can be expressed as Eq. (6):

$$δ κ {t}_{2} = ( {ϵ}_{2} - {ϵ}_{1} ) \frac{6 β y ( 1 + β )}{1 + 4 β γ + 6 {β}^{2} γ + 4 {β}^{3} + {β}^{4} {γ}^{2}}$$

where δκt₂ is the change in curvature after a temperature change (ΔT), β=t₁/t₂, γ=E₁/E₂, ϵᵢ=ϵ_{p,i}−ΔTαᵢ, ϵ_{p,i} is the permanent strain from the curing process for material i, tᵢ is the thickness of material i, Eᵢ is the elastic modulus of material i, αᵢ is the reversible CTE for material i, and subscripts 1 and 2 denote low and high CTE materials, respectively. Validation of Equation 6 was accomplished by printing high fidelity bilayer with different ink combinations with respect to B and comparing the measured curvature after an imposed temperature change to the prediction. Using Equation 6, we choose a pair of inks to print a bilayer composed of one high α ink that is not electrically conductive (1:1:8+B), while the other ink possesses negative a and high σ (1:0.2+15% v/v CF+47% v/v CB) allowing us to use this layer as a Joule heating element as shown in FIG. 8a. Due to the curing-based permanent shrinkage, the curvature of the transformed state (T=25° C.) of the bilayers 810 is slightly larger than the CTE alone 812; hence the shrinkage generates a more pronounced curvature response while still maintaining reversibility. When heating the conductive layer via Joule heating, the bilayer structure exhibits a controllable, repeatable, and pronounced actuation response by modulating the Joule heating power. This is shown across images 820 of FIG. 8b. We actuate the bilayer from room temperature at 0 W, up to 160° ° C. at 2.2 W. To predict the behavior of these electrically controllable bilayers, we developed an electro/thermal-mechanical model (FIGS. 8c-d). The measured surface temperature, curvature, and change in electrical resistance (R/R₀) as a function of the Joule heating power exhibits good agreement with our model (FIGS. 8c-d). By examining R/R₀, we can observe a one-to-one correlation between the average thermal strain experienced throughout the bilayer and the change in the electrical resistance during Joule heating (FIG. 8d). Hence, changes in strain and R/R₀ can be directly programmed with power inputs, allowing us to enable self-sensing capabilities. Further, characterizing the sensitivity of our device, shows that it achieves a high and repeatable sensitivity with a gauge factor of 40.80±0.82, which is significantly higher than commercially available sensors and comparable to state of the art carbon-based sensors. FIG. 8e shows the cycling heating response of our bilayer up to 54% of the maximum tested actuation power. The response is highly repeatable, with more than 20,000 actuation cycles. Unlike other highly sensitive carbon-based sensors, these self-sensing bilayers exhibit no signal drift due to the immobile carbon filler network, made possible by the stiff epoxy matrix.

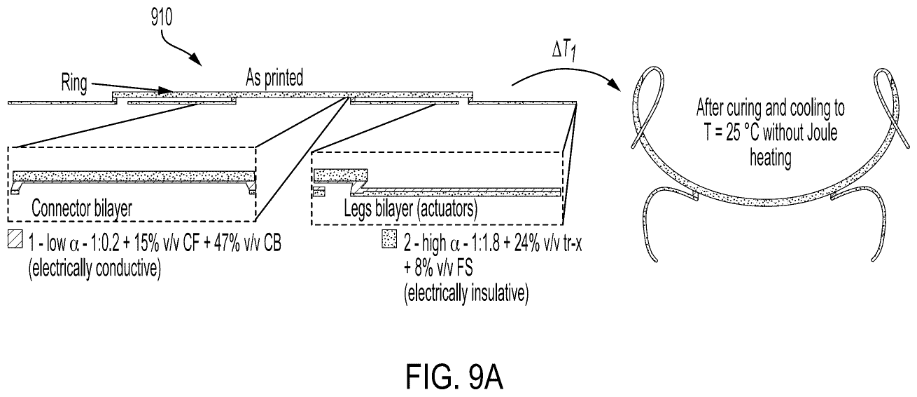

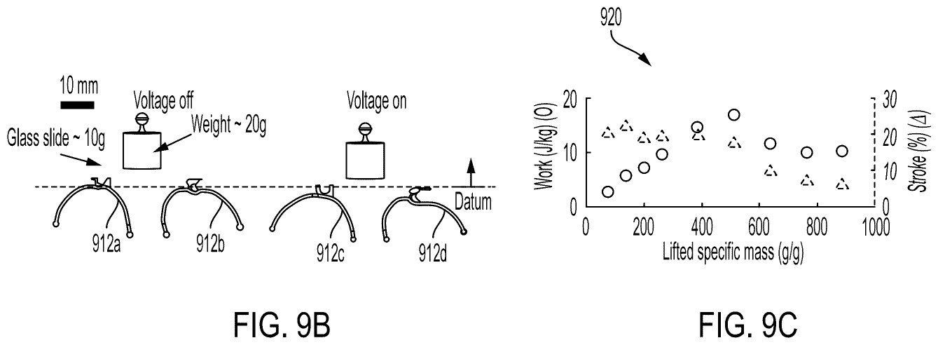

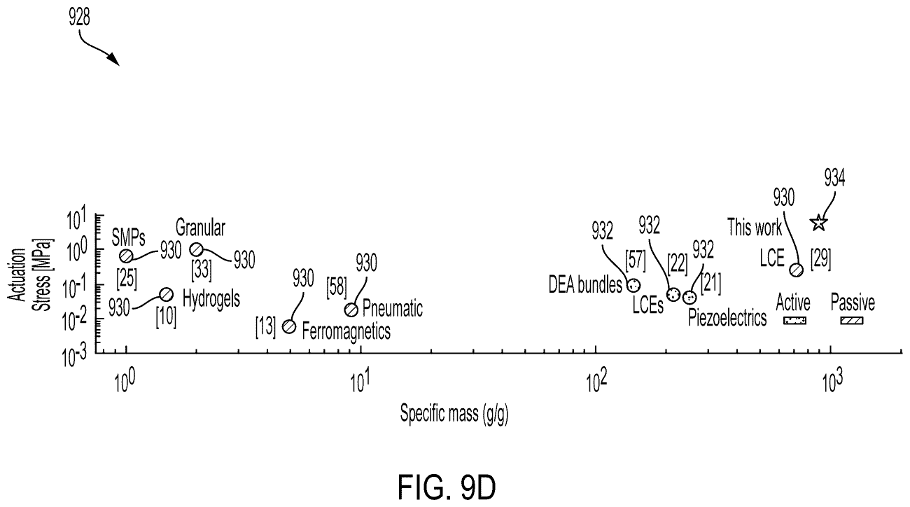

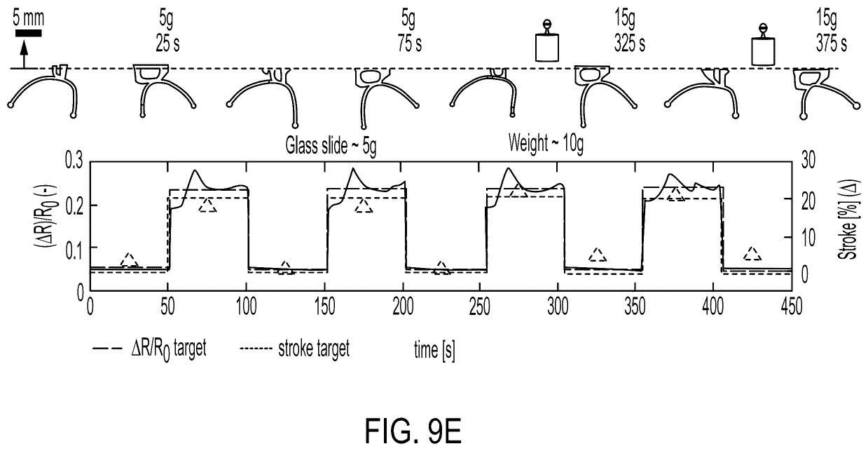

Referring now to FIGS. 9a-9e the capabilities of these epoxy composites bilayers are demonstrated through a morphable weightlifting robot using 4D multi-material printing. Particularly, FIG. 9a shows a schematic of the lifting robot 910 after printing while FIG. 9b shows photographs of the robot 912a-912d being actuated. FIG. 9b illustrates how we evaluated the actuation performance of this robot. The actuation cycle was generated by providing a constant power input (˜2 W) for ˜15 seconds (˜1 time constant), followed by a power cut-off and a cooldown interval of about 25 seconds (˜2 time constant). Following, we add external weights (combinations of glass slides and/or calibrated weights) on top of the robot, with gradual increments, to test the performance of the actuation cycle with variable loads. As for performance metrics, we track the specific work, lifted specific mass, and actuation stroke. FIG. 9c shows a graph 920 of specific work and stroke of the lifting robot, as well as lifted mass. Graph 920 shows the lifting robot yields maximum specific work and stroke of 16.99 J kg⁻¹ and 22.29%, respectively, while lifting a maximum weight of 885.90 times its own weight. This current design can maintain its targeted 20% stroke up to 470 times its own weight. After this point, the reversible stroke is reduced by additional deflections on the actuator legs due to the heavy loads. Unlike prior work, all these tests were performed on a self-standing configuration, thus, the actuation nature of this structure generated pushing forces rather than pulling forces, which is difficult to achieve with soft materials.

Referring now to FIG. 9d, performance metrics of 3D printed actuators are shown in graph 928, with graph points 930 being passive actuators and graph points 932, 934 being active actuators. The graph 928 shows the actuation stress and specific mass for relevant prior work on 3D-printed responsive actuators. The various actuators are differentiated based on how the stimulus for actuation is generated: via change in environment conditions through additional components (passive) (e.g., hot plates, ovens, external magnets, water bath) or using internal stimuli (active) (e.g., voltage). Comparing our robot (graph point 934) with the highest performance passive 3D printable actuator, ours shows improvements of 24× and 1.24× on actuation stress and specific mass, respectively. Similarly, comparing our robot with the highest performance active 3D printable actuator, ours shows improvements of 150× and 3.55× on actuation stress and specific mass, respectively. Notably our results stand out significantly with the highest actuation stress and specific mass capacity amongst the active actuators, due to the intrinsic electrical properties of our materials. Finally, comparing the performance of our robotic actuators to commercially available ones, ours is the fifth-highest performing actuator (in both actuation stress and specific lifted mass) out of nineteen different types.

Given that these actuators are highly responsive and possess self-sensing capabilities, we explored regulating their actuation response via closed-loop control (see FIG. 9e). Specifically, a PID control system is programmed with a target ΔR/R₀ that autoregulates the lifting robot to reach different targets through time, even with large external weight disturbances. We designated a target square wave trajectory with ΔR/R₀ of 5% and 23%, corresponding to target strokes of ˜3% and ˜20%, respectively, and periods of 50 seconds, which is ˜4.2 times bigger that the time constant for this system. The system rapidly adjusts the power to achieve the target output, such that the ΔR/R₀ responses lie within 4.79% and 0.77% overshoot and undershoot, respectively. Notably, this robot can achieve targeted actuation while experiencing disturbances more than 170 times its own weight.

To use our material palette for morphing planar structures into complex target shapes, we arrange multiplexed pairs of bilayers into a heterogenous lattice in which we have control of the initial distance between nodes (L) and the number of cells (N) within the lattice of the printed structures, and the initial sweep angle (θᵢ) of every rib, which is considered an independent degree of freedom and is indexed throughout the lattice to achieve targeted designs. The linear growth factor (s) for these structures can be expressed as Eq. (7):

$${s}_{i} = \frac{L}{\tilde{L}} = \frac{2 sin ( \frac{1}{4} {\tilde{θ}}_{i} ( 2 + \frac{\tilde{L} {δ}_{κ}}{sin ( {\tilde{θ}}_{i} / 2 )} ) )}{2 sin ( {\tilde{θ}}_{i} / 2 ) + \tilde{L} δκ}$$

where L is the new distance between nodes due to ok (from Eq. 6). Up to four different materials are used in the cross-section, which allows us to program the intrinsic and extrinsic curvatures of the resulting shapes. We demonstrate the efficacy of this approach for our new material system by printing flat square lattices that morph into self-standing spherical caps, saddles, and alternating gaussian and mean curvatures. Unlike prior work using soft 4D printed materials, these materials do not sag under their own weight. We achieve large self-standing spherical caps of ˜200 mm width and ˜200 mm length, which is 11 times larger in projected area than prior work. Calculations of scaling analysis show that our structures can be printed as large as ˜1000 mm×1000 mm without reaching sagging, which would be ˜3 orders of magnitude larger than prior work with soft 4D printed materials.

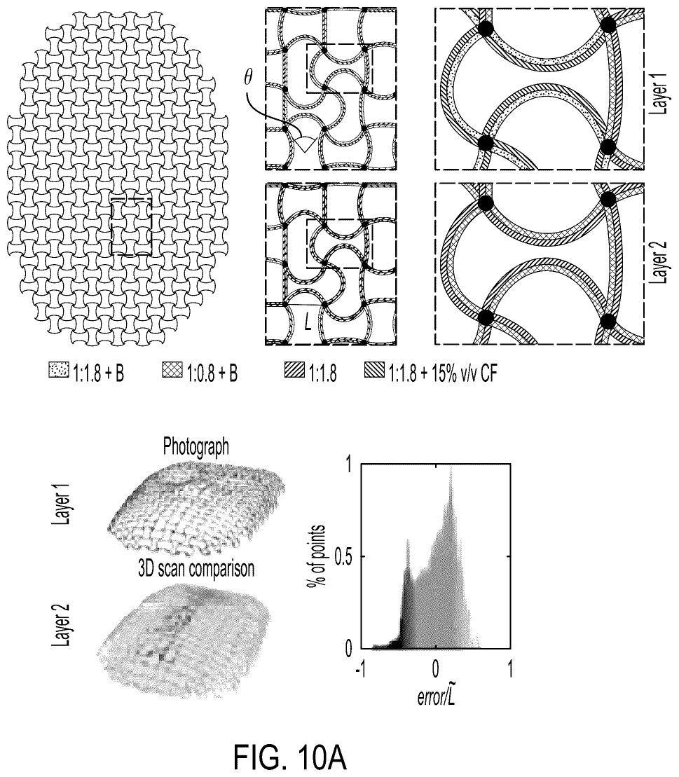

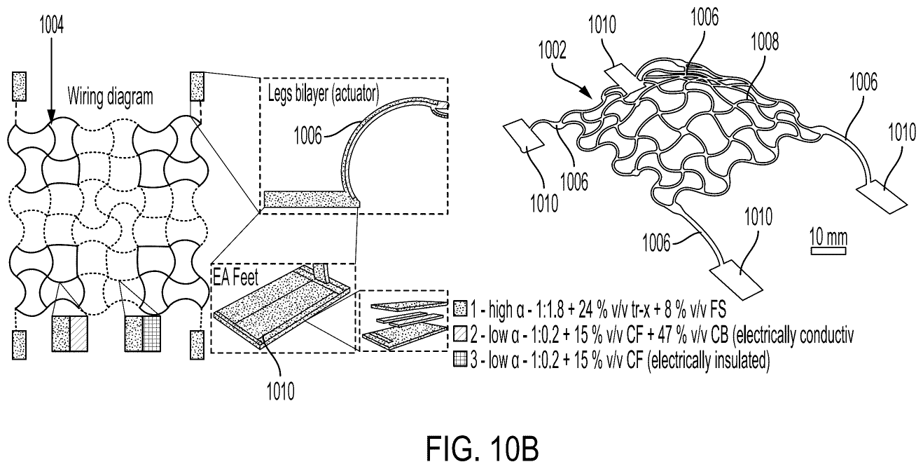

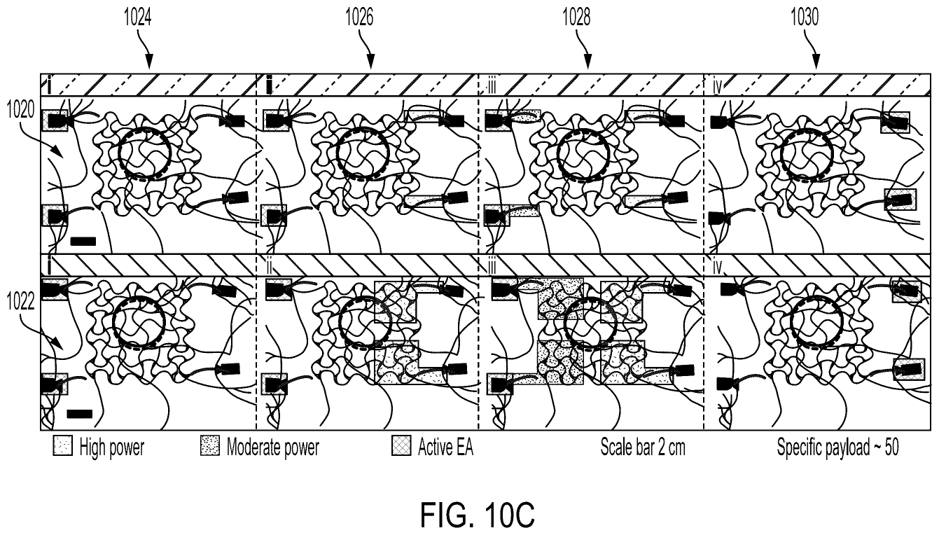

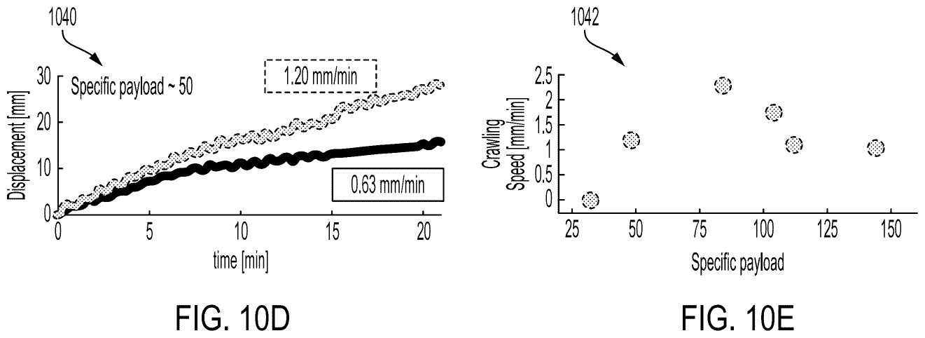

Referring now to FIGS. 10a-10e, to show the capability of our approach to create shapes with complex geometrical features and self-standing structures, we printed a planar lattice that transform into a self-supported human face. We choose to replicate C. F. Gauss' face, starting with a 3D target surface mesh generated from a painting of Gauss through a machine learning algorithm. We conformally projected the face to the plane and discretized the planar projection using a lattice with L=10 mm and with the number of cells in the width (Nₓ) and length (N_{y}) of 17 and 26, respectively. The lattice discretization and associated inverse-design procedure follows the approach detailed in prior work, but using material properties from our new heterogeneous polymer composites. We find among all ribs the maximum and minimum required growth factors to be s=1.46 and s=0.44, respectively. The largest growth factors are required near the nose and the chin, where the target mesh has the most substantial Gaussian curvature. To evaluate the accuracy of our printed face, we generated a 3D reconstruction of the transformed face using laser-scanning techniques. By fitting the scan data with our target mesh, we can compute the smallest distance from each point on the scanned face to the target shape. Using this as an error metric, we normalize it as the error/L. The distribution of the error/L exhibits a 95% confidence interval within ±0.519, which is ˜16% more accurate than prior work. Notably, we showed that we can maintain the high accuracy of the 4D printing method while enhancing the mechanical behavior of the transformed structures to enable big, stiff, and complex self-standing shape-shifting structures.

To further test the multifunctionality of our approach, we combine the electrically responsive actuators (FIGS. 8a-9e) and 4D printed lattices (FIG. 5a) to develop an electrically controlled robotic lattice capable of multiple modes of crawling locomotion (1002 of FIG. 10b). We chose three different materials, one non-conductive with high α (1:1.8+24% v/v tr-x+8% v/v FS), and two with much lower values of α, one of which is electrically conductive (1:0.2+15% v/v CFs+47% v/v CB) and the other is electrically insulative (1:0.2+15% v/v CFs). Using these materials, we print a planar square lattice that deploys to a spherical cap, containing conductive pathways within the lattice to electrically activate sections of the structure. The structure is a flat square lattice with L=15 mm and N=6, with θᵢ, programmed via stereographic projection to transform into a spherical cap with an opening angle of 135°. This larger opening angle was selected to maximize Gaussian curvature, which provides an enhanced mechanical advantage by achieving higher stiffness compared to planar structures. The lattices possess four electrically isolated conductive quadrants, which allow individual control of each section of the morphing surface. To improve the actuation stroke, we add simple bilayers 1006 to each corner of the lattice, referred to here as ‘legs’. These legs 1006 function to lift and support the lattice body 1008 and can be individually actuated. Finally, we print four Electro Adhesive (EA) pads 1010 denoted here as ‘feet’, to enhance the adhesion between the substrate and the locomotive lattice.

FIG. 10c shows two different gaits modes that were utilized with the robot, with the first being shown via the images in the top row 1020 and the second being shown via the images in the bottom row 1022. The first gait mode (1020) consisted of using only the bilayer legs of the robot as the actuators, while the second gait mode (1022) uses the combined stroke generated by the bilayer legs 1006 and the lattice body 1008. The actuation sequence for both gait modes starts by activating the posterior EA feet to anchor the device to the substrate (images in column 1024). Then, the anterior actuator legs are actuated at maximum power (2.64 W) for ˜10 seconds (images in column 1026). While maintaining the anterior feet and legs engaged, we activated the posterior legs at 75% of the maximum power and waited for ˜10 seconds (images in column 1028); this ensures that the forces generated by the actuator legs are lower than the adhesive forces of the EA feet. Then, we simultaneously disengage the posterior EA feet, engage the anterior EA feet, cut off the power of anterior and posterior actuators (images in column 1030), and wait for ˜30 seconds (˜2 time constant until all parts of the robot cool to room temperature, dragging its own body forward toward the anchored anterior EA feet. FIG. 10d shows a graph 1040 of the displacement of the robotic lattice over time for the two types of gaits at a fixed specific payload (weight of payload over the weight of robot) of ˜50. The resulting crawling speed of the combined mode (body+legs) is 1.90 times faster than the single actuation mode (legs only). This improvement is attributed to the combined displacement generated by the bilayer legs and the lattice body.

Furthermore, we evaluated the payload capacity with respect to crawling speed for the faster gait strategy (legs+body), as shown in graph 1042 of FIG. 10e. We found that carrying an external load up to 84 times its own weight onto the lattice optimally enhances the crawling speed (graph 1042), which can be attributed to an increase in the adhesion force between the substrate and the robot due to a higher normal force, thus reducing the slipping between the robot and the substrate. After a specific load of 84, the speed gets reduced by ˜50%. This reduction can be attributed to been carrying loads that are higher than the actuation stress capacity of the actuators (legs+body), hence hindering the locomotion speed. Nonetheless, increasing the specific load further demonstrates that the robot still achieves forward locomotion up to a payload of 144 times its own weight.

Thus as explained above, disclosed herein is a new heterogeneous polymer composites for 4D printing with high stiffness, tunable coefficient of thermal expansion (α), and electrical conductivity (σ). We demonstrate that printed bilayers of these materials exhibit programmable and predictable thermal and mechanical responses, with high gauge factor self-sensing while being actuated via Joule heating. These materials enable the fabrication of a new type of stiff lifting actuators with highly repeatable self-sensing capabilities, which allows the implementation of closed-loop control for modulated actuation, with specific load capacities up to 885.90 times its own weight. This robot shows improvements of 150× and 3.55× on actuation stress and specific mass, respectively, compared to existing 3D printed active actuators. Furthermore, comparing the performance of our robotic actuator to 3D printed commercially available actuators, ours is the fifth highest performance actuator out of nineteen different types. We show that these materials can be combined with multi-material 4D printing of lattice structures to develop large, stiff, and complex shape-shifting structures. Combining the multifunctionalities of these materials with the morphing lattice approach, we develop a stiff, electrically controllable shape-shifting robotic lattice with multiple crawling locomotion modes. With further development, these materials can be implemented into new composite structural designs to develop stronger, autonomous morphing systems such as sensors, actuators, antennas, and robots. Notably, while electrical actuators are shown as an exemplary 4D printing actuation mechanism herein, it should be understood that other types of 4D printing actuation mechanisms, such as heat (e.g. heating via an electrical signal), or the application of force, for example, may also be used.

All references cited herein are incorporated by reference, as though fully set forth herein. All orientations and arrangements of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. A 3D printing material comprising:
a liquid metal emulsion including eutectic Gallium Indium (eGaIn), sodium carboxylmethyl cellulose (NaCMC), and water.

2. The 3D printing material of claim 1, wherein the water is de-ionized water.

3. The 3D printing material of claim 1, wherein the eGaIn forms liquid metal droplets having a diameter of between 7 μm and 120 μm.

4. The 3D printing ink of claim 1, wherein the 3D printed ink further comprises a cured base layer, and the liquid metal emulsion is applied on top of the cured base layer.

5. A method of creating a stretchable electronic device with 3D printing comprising:
printing a substrate using a body ink;
curing the substrate;
printing traces on top of the substrate using a 3D printing ink comprising a liquid metal emulsion formed from a liquid metal alloy within a solution;
packaging and curing the combined substrate and traces to create the stretchable electronic device;
electrically activating the stretchable electronic device by stretching the stretchable electronic device; and
allowing the stretchable electronic device to return to a relaxed state.

6. The method of claim 5, wherein the liquid metal alloy is eutectic Gallium Indium (eGaIn) and the solution is sodium carboxylmethyl cellulose (NaCMC) and water.

7. The method of claim 6, wherein the method comprises, after printing traces:
applying an adhesive between traces; and
coupling an electronic component to the adhesive to form an electrical connection with the traces.

8. A method of 4D printing comprising:
creating a heterogenous polymer composite ink starting with an epoxy resin material;
tuning the thermal expansion (α) of the heterogenous polymer composite ink by adding a first additional material different than the epoxy resin;
tuning the electrical conductivity (σ) of the heterogenous polymer composite ink by adding a second additional material different than the first material or the epoxy resin;
printing a flat lattice structure using the heterogenous polymer composite ink; and
actuating the flat lattice structure via a 4D printing technique to change the flat lattice structure to a 3D structure.

9. The method of claim 8, wherein the flat lattice structure is actuated via the application of an electrical signal.

10. The method of claim 8, wherein the a heterogenous polymer composite ink includes a first layer and a second layer, the first layer having a low thermal expansion (α) and being electrically conductive, and the second layer having a high thermal expansion (α) and being electrically insulative.

11. The method of claim 8, further comprising:
after creating the heterogenous polymer composite ink and before printing the flat lattice structure, tuning the elastic modulus (E) for the heterogenous polymer composite ink by adding third second additional material different from any of the epoxy resin, the first additional material, and the second additional material.

12. The method of claim 8, further comprising adding separately actuatable bilayers to the flat lattice structure.

13. The method of claim 12, further comprising creating locomotion by actuating the separately actuatable bilayers.

14. A composite for 4D printing comprising:
an epoxy resin, a cross-linker, and at least one of the following: fumed silica (FS), carbon nanotubes (CNT), carbon fiber (CF).

15. The composite of claim 14, wherein:
the composite includes only one of the following: FS or CNT; and
the composite includes at least one additional material of the following: CF; carbon black (CB); and a non-ionic surfactant.
